(19) United States
(12) Patent Application Publication
(10) Pub. No.: US 2011/0101270 A1
(43) Pub. Date: May 5, 2011

(54) LIQUID-CRYSTALLINE MEDIUM

(76) Inventors: Atsutaka Manabe, Bensheim (DE); Cecile Schott, Darmstadt (FR); Elvira Montenegro, Weinheim (DE); Michael Junge, Pfungstadt (DE)

(21) Appl. No.: 12/988,907

(22) PCT Filed: Mar. 26, 2009
(86) PCT No.: PCT/EP09/02231

§ 371 Date: Oct. 21, 2010

(30) Foreign Application Priority Data
Apr. 22, 2008 (DE) 10 2008 020 058.1

(51) Int. Cl. C09K 19/32

(52) U.S. Cl. 252/299.62

(57) ABSTRACT

The invention relates to a liquid-crystalline medium having a nematic phase and negative dielectric anisotropy which comprises
a) one or more compounds of the formula I

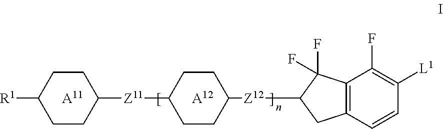

b) 5.0·10⁻³% by weight to 1.0% by weight of one or more compounds selected from the group of the compounds of the formulae II-A to II-F:

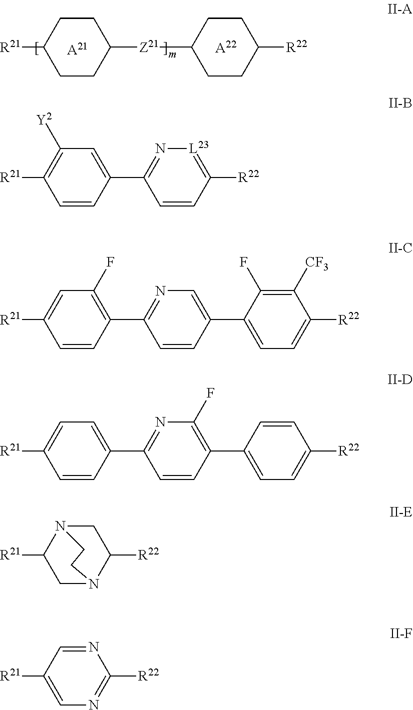

and
c) 5.0·10⁻⁴% by weight to 1.0% by weight of one or more compounds which contain one, two or more groups of the formula II-G

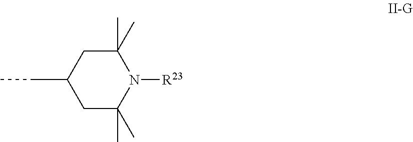

in which the parameters have the meanings indicated in claim 1,
to the use thereof in an electro-optical display, particularly in an active-matrix display based on the VA, ECB, PALC, FFS or IPS effect, and to displays of this type, and to the joint use of one or more of the compounds selected from the group of the compounds of the formulae II-A to II-F with one or more compounds which contain the group II-G for the stabilisation of a liquid-crystalline medium which comprises one or more compounds of the formula I.

The present invention relates to liquid-crystal media and to the use thereof in liquid-crystal displays, and to these liquid-crystal displays, particularly liquid-crystal displays which use the ECB (electrically controlled birefringence) effect with dielectrically negative liquid crystals in a homeotropic starting alignment. The liquid-crystal media according to the invention are distinguished by a particularly short response time in the displays according to the invention at the same time as a high voltage holding ratio (VHR for short).

The principle of electrically controlled birefringence, the ECB (electrically controlled birefringence) effect or DAP (deformation of aligned phases) effect, was described for the first time in 1971 (M. F. Schieckel and K. Fahrenschon, “Deformation of nematic liquid crystals with vertical orientation in electrical fields”, Appl. Phys. Lett. 19 (1971), 3912). Papers by J. F. Kahn (Appl. Phys. Lett. 20 (1972), 1193) and G. Labrunie and J. Robert (J. Appl. Phys. 44 (1973), 4869) followed.

The papers by J. Robert and F. Clerc (SID 80 Digest Techn. Papers (1980), 30), J. Duchene (Displays 7 (1986), 3) and H. Schad (SID 82 Digest Techn. Papers (1982), 244) have shown that liquid-crystalline phases must have high values for the ratio between the elastic constants K₃/K₁, high values for the optical anisotropy Δn and values for the dielectric anisotropy Δ∈ of ≦−0.5 in order to be suitable for use for high-information display elements based on the ECB effect. Electro-optical display elements based on the ECB effect have a homeotropic edge alignment (VA technology=vertically aligned). Dielectrically negative liquid-crystal media can also be used in displays which use the so-called IPS effect.

Industrial application of this effect in electro-optical display elements requires LC phases which have to meet a multiplicity of requirements. Particularly important here are chemical resistance to moisture, air and physical influences, such as heat, radiation in the infrared, visible and ultraviolet regions, and direct and alternating electric fields.

Furthermore, LC phases which can be used industrially are required to have a liquid-crystalline mesophase in a suitable temperature range and low viscosity.

None of the series of compounds having a liquid-crystalline mesophase that have been disclosed hitherto includes a single compound which meets all these requirements. Mixtures of two to 25, preferably three to 18, compounds are therefore generally prepared in order to obtain substances which can be used as LC phases.

Matrix liquid-crystal displays (MLC displays) are known. Non-linear elements which can be used for individual switching of the individual pixels are, for example, active elements (i.e. transistors). The term “active matrix” is then used, where in general use is made of thin-film transistors (TFTs), which are generally arranged on a glass plate as substrate.

A distinction is made between two technologies: TFTs comprising compound semiconductors, such as, for example, CdSe, or TFTs based on polycrystalline and, inter alia, amorphous silicon. The latter technology currently has the greatest commercial importance worldwide.

The TFT matrix is applied to the inside of one glass plate of the display, while the other glass plate carries the transparent counterelectrode on its inside. Compared with the size of the pixel electrode, the TFT is very small and has virtually no adverse effect on the image. This technology can also be extended to fully colour-capable displays, in which a mosaic of red, green and blue filters is arranged in such a way that a filter element is opposite each switchable pixel.

The TFT displays most used hitherto usually operate with crossed polarisers in transmission and are back-lit. For TV applications, IPS cells or ECB (or VAN) cells are used, whereas monitors usually use IPS cells or TN cells and notebooks, laptops and mobile applications usually use TN cells. The term MLC displays here covers any matrix display with integrated non-linear elements, i.e. besides the active matrix also displays with passive elements, such as varistors or diodes (MIM=metal-insulator-metal).

MLC displays of this type are particularly suitable for TV applications, monitors and notebooks or for displays with a high information density, for example in automobile manufacture or aircraft construction. Besides problems regarding the angle dependence of the contrast and the response times, difficulties also arise in MLC displays due to insufficiently high specific resistance of the liquid-crystal mixtures [TOGASHI, S., SEKIGUCHI, K., TANABE, H., YAMAMOTO, E., SORIMACHI, K., TAJIMA, E., WATANABE, H., SHIMIZU, H., Proc. Eurodisplay 84, September 1984: A 210-288 Matrix LCD Controlled by Double Stage Diode Rings, pp. 141 ff., Paris; STROMER, M., Proc. Eurodisplay 84, September 1984: Design of Thin Film Transistors for Matrix Addressing of Television Liquid Crystal Displays, pp. 145 ff., Paris]. With decreasing resistance, the contrast of an MLC display deteriorates. Since the specific resistance of the liquid-crystal mixture generally drops over the life of an MLC display owing to interaction with the inside surfaces of the display, a high (initial) resistance is very important for displays that have to have acceptable resistance values over a long operating period.

Displays which have used the ECB effect have become established as so-called VAN (vertically aligned nematic) displays besides IPS (in-plane switching) displays (for example: Yeo, S. D., Paper 15.3: “An LC Display for the TV Application”, SID 2004 International Symposium, Digest of Technical Papers, XXXV, Book II, pp. 758 & 759), and the long-known TN (twisted nematic) displays, as one of the three more recent types of liquid-crystal display that are currently the most important, in particular for television applications.

The most important designs that should be mentioned are: MVA (multi-domain vertical alignment, for example: Yoshide, H. et al., Paper 3.1: “MVA LCD for Notebook or Mobile PCs . . . ”, SID 2004 International Symposium, Digest of Technical Papers, XXXV, Book I, pp. 6 to 9, and Liu, C. T. et al., Paper 15.1: “A 46-inch TFT-LCD HDTV Technology.”, SID 2004 International Symposium, Digest of Technical Papers, XXXV, Book II, pp. 750 to 753), PVA (patterned vertical alignment, for example: Kim, Sang Soo, Paper 15.4: “Super PVA Sets New State-of-the-Art for LCD-TV”, SID 2004 International Symposium, Digest of Technical Papers, XXXV, Book II, pp. 760 to 763) and ASV (advanced super view, for example: Shigeta, Mitzuhiro and Fukuoka, Hirofumi, Paper 15.2: “Development of High Quality LCDTV”, SID 2004 International Symposium, Digest of Technical Papers, XXXV, Book II, pp. 754 to 757).

In general form, the technologies are compared, for example, in Souk, June, SID Seminar 2004, Seminar M-6: “Recent Advances in LCD Technology”, Seminar Lecture Notes, M-6/1 to M-6/26, and Miller, Ian, SID Seminar 2004, Seminar M-7: “LCD-Television”, Seminar Lecture Notes, M-7/1 to M-7/32. Although the response times of modern ECB displays have already been significantly improved by addressing methods with overdrive, for example: Kim, Hyeon Kyeong et al., Paper 9.1: “A 57-in. Wide UXGA TFT-LCD for HDTV Application”, SID 2004 International Symposium, Digest of Technical Papers, XXXV, Book I, pp. 106 to 109, the achievement of video-compatible response times, in particular in the switching of grey shades, is still a problem which has not yet been solved to a satisfactory extent.

ECB displays, like ASV displays, use liquid-crystalline media of negative dielectric anisotropy (As), whereas TN and to date all conventional IPS displays use liquid-crystalline media of positive dielectric anisotropy.

In liquid-crystal displays of this type, the liquid crystals are used as dielectrics, whose optical properties change reversibly on application of an electrical voltage.

Since in displays in general, i.e. also in displays in accordance with these mentioned effects, the operating voltage should be as low as possible, use is made of liquid-crystal media which are generally predominantly composed of liquid-crystal compounds, all of which have the same sign of the dielectric anisotropy and have the highest possible value of the dielectric anisotropy. In general, at most relatively small proportions of neutral compounds and if possible no compounds having a sign of the dielectric anisotropy which is opposite to the medium are employed. In the case of liquid-crystal media of negative dielectric anisotropy for ECB displays, predominantly compounds of negative dielectric anisotropy are thus employed. The liquid-crystal media employed generally consist predominantly and usually even essentially of liquid-crystal compounds of negative dielectric anisotropy.

In the media used in accordance with the present application, at most significant amounts of dielectrically neutral liquid-crystal compounds and generally only very small amounts of dielectrically positive compounds or even none at all are typically employed, since in general the liquid-crystal displays are intended to have the lowest possible addressing voltages.

However, the liquid-crystal media of the general prior art having correspondingly low addressing voltages usually have relatively low electrical resistance values or a low VHR and often result in undesired flicker and/or inadequate transmission in the displays. In addition, they do not have adequate stability at high temperatures and/or on UV exposure, at least if they have correspondingly high polarity, as is necessary for low addressing voltages.

In addition, the addressing voltage of the displays of the prior art is often too high, in particular for displays which are not connected directly or not continuously to the power supply network, such as, for example, displays for mobile applications.

In addition, the phase range must be sufficiently broad for the intended application.

The response times of the liquid-crystal media in the displays must be improved, i.e. reduced. This is particularly important for displays for television or multimedia applications. In order to improve the response times, it has repeatedly been proposed in the past to optimise the rotational viscosity of the liquid-crystal media (γ₁), i.e. to achieve media having the lowest possible rotational viscosity. However, the results achieved here are inadequate for many applications and therefore make it appear desirable to find further optimisation approaches.

The disadvantage of the MLC displays disclosed hitherto is based on their comparatively low contrast, the relatively high viewing-angle dependence and the difficulty of producing grey shades in these displays, as well as their inadequate VHR and their inadequate lifetime.

Liquid-crystal media comprising virtually dielectrically neutral indanes are mentioned, for example, in JP 2005-047 980 A. Indanes of negative dielectric anisotropy are disclosed, for example, in DE 101 35 499 A1, DE 103 54 404 A1 and DE 10 2004 046 103 A1.

Nematic liquid-crystal mixtures of negative dielectric anisotropy which comprise laterally fluorinated indane derivatives of the formula

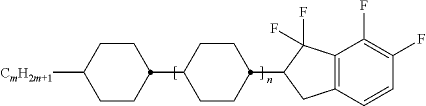

in which m denotes an integer and n denotes 0 or 1, are known, for example, from WO 2004/048500 A1. According to the disclosure therein, these media may optionally also comprise stabilisers of various types, such as, for example, phenols and sterically hindered amines (HALS). These media are characterised by relatively low threshold voltages and by relatively high stabilities. However, their voltage holding ratio may drop after intense exposure. In addition, a yellowish discoloration sometimes occurs after extremely intense exposure.

The use of various stabilisers in liquid-crystalline media is described, for example, in JP (S)55-023169 (A), JP (H)05-117324 (A), WO 02/18515 A1 and JP (H) 09-291282 (A).

Adequate stability of the media to extreme stresses, in particular to high temperatures and/or intense UV exposure, is very particularly important. This may be crucial, in particular, in applications in displays in mobile equipment, such as, for example, mobile telephones.

There thus continues to be a great demand for MLC displays having very high specific resistance at the same time as a large working-temperature range, short response times and a low threshold voltage with the aid of which various grey shades can be produced and which have, in particular, a good and stable VHR.

Surprisingly, it has been found that it is possible to achieve liquid-crystal displays which, in particular in ECB displays, have a low threshold voltage at the same time as short response times and at the same time have a sufficiently broad nematic phase, a favourable birefringence (Δn) and a stable, high VHR.

Media of this type can be used, in particular, for electro-optical displays having active-matrix addressing based on the ECB effect and for IPS (in-plane switching) displays.

The invention is based on the object of providing MLC displays, not only for monitor and TV applications, but also for mobile telephones and navigation systems, which are based on the ECB or IPS effect, do not have the disadvantages indicated above, or only do so to a lesser extent, and at the same time have very high specific resistance values. In particular, it must be ensured for mobile telephones and navigation systems that they also work at extremely high and extremely low temperatures.

Surprisingly, it has now been found that this object can be achieved if nematic liquid-crystal mixtures which comprise at least one compound of the formula I and 5.0·10⁻³% by weight to 1.0% by weight of at least one compound selected from the group of the compounds of the formulae II-A to II-F and 5.0·10⁻⁴% by weight to 1.0% by weight, at least one compound which contains one or more groups of the formula II-G are used in these display elements.

The invention thus relates to a liquid-crystalline medium based on a mixture of polar compounds which comprises at least one compound of the formula I and 5.0·10⁻³% by weight of at least one compound selected from the group of the compounds of the formulae II-A to II-F and 1.0·10⁻³% by weight of at least one compound which contains one or more groups of the formula II-G.

The mixtures according to the invention exhibit very broad nematic phase ranges with clearing points ≧70° C., very favourable values for the capacitive threshold, relatively high values for the holding ratio and at the same time good low-temperature stabilities at −20° C. and −30° C., and very low rotational viscosities. Furthermore, the mixtures according to the invention are distinguished by a good ratio of clearing point and rotational viscosity and by high negative dielectric anisotropy.

The invention thus relates to a liquid-crystalline medium having a nematic phase and negative dielectric anisotropy which comprises
a) one or more compounds of the formula I

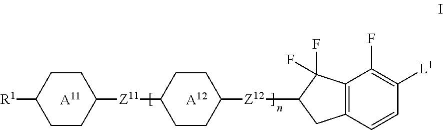

in which
R¹ denotes H, an unsubstituted alkyl or alkenyl radical having up to 15 C atoms, where, in addition, one or more CH₂ groups in these radicals may be replaced by —O—, —S—,

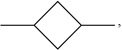

—C≡C—, —CF₂—O—, —O—CF₂—, —CO—O— or —O—CO— in such a way that O atoms are not linked directly to one another, where, in all groups, one or more H atoms may be replaced by halogen atoms,
L¹ denotes H or F, preferably F,

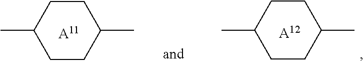

independently of one another, denote

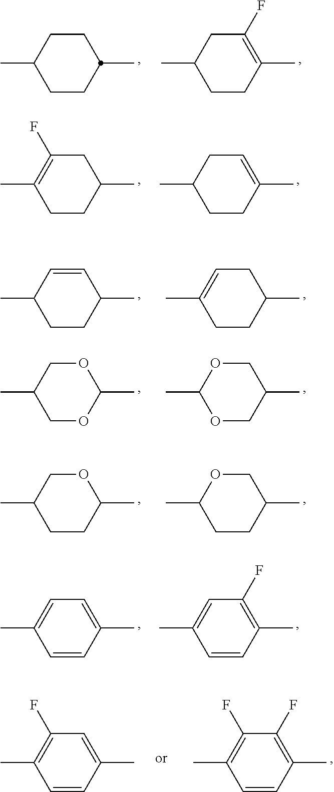

preferably

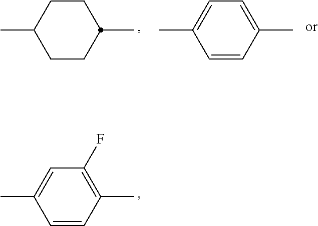

particularly preferably

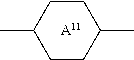

denotes

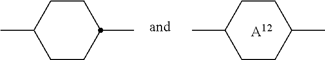

denotes

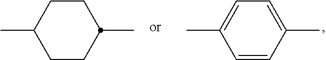

Z¹¹ and Z¹² each, independently of one another, denote —CH₂—CH₂—, —CH₂—CF₂—, —CF₂—CH₂—, —CF₂—CF₂—, —CH═CH—, —CF═CH—, —CH═CF—, —CF═CF—, —C≡C—, —CH₂—O—, —O—CH₂—, —O—, —CH₂—, —CO—O—, —O—CO—, —CF₂—O—, —O—CF₂— or a single bond, and
n denotes 0 or 1,
b) 5.0·10⁻³% by weight to 1.0% by weight, preferably to 0.50% by weight, particularly preferably to 0.10% by weight, of one or more compounds selected from the group of the compounds of the formulae II-A to II-F:

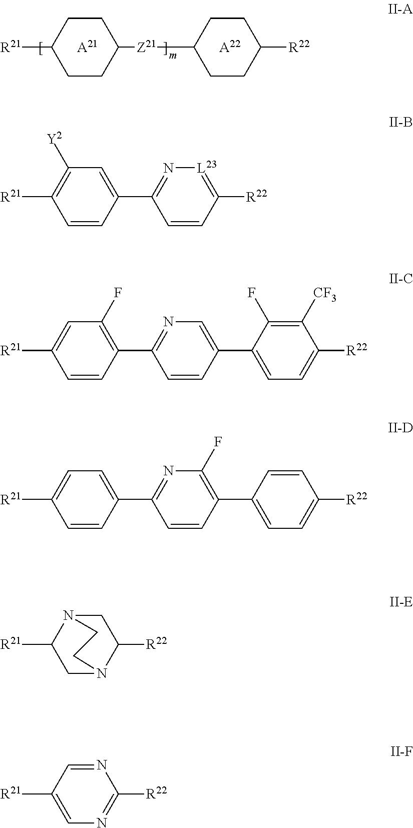

in which
R²¹ and R²² each, independently of one another, denote H, an unsubstituted alkyl or alkenyl radical having up to 15 C atoms, where, in addition, one or more CH₂ groups in these radicals may be replaced by —O—, —S—,

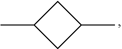

—C≡C—, —CF₂—O—, —O—CF₂—, —CO—O— or —O—CO— in such a way that O atoms are not linked directly to one another, and R²² alternatively also denotes X², and in formulae II-B and II-C R²¹ preferably denotes alkoxy and R²² preferably denotes H or alkyl,
X² denotes F, Cl, CN or —OCF₃,
   one of the rings

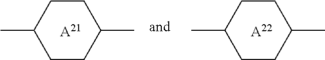

present denotes

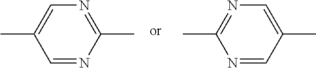

and the other, if present, denotes

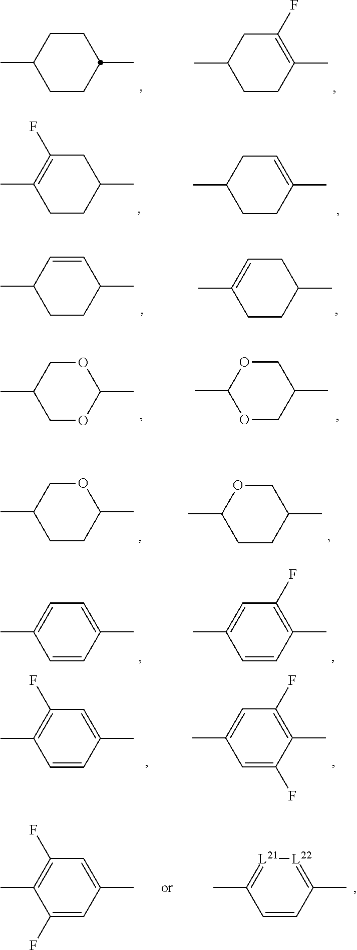

one of
L²¹ and L²² denotes ═C(—F)— or ═N— and the other denotes ═C(—F)—,
L²³ denotes ═C(—H)— or ═N—,
Y² denotes H or F,
Z²¹ denotes —CH₂—CH₂—, —CH₂—CF₂—, —CF₂—CH₂—, —CF₂—CF₂—, —CH═CH—, —CF═CH—, —CH═CF—, —CF═CF—, —C≡C—, —CH₂—O—, —O—CH₂—, —O—, —CH₂—, —CO—O—, —O—CO—, —CF₂—O—, —O—CF₂— or a single bond, and
m denotes 0 or 1,
   and
c) 5.0·10⁻⁴% by weight to 1.0% by weight, preferably to 0.10% by weight, particularly preferably 1.0·10⁻³% by weight to 1.0% by weight, preferably to 0.10% by weight, of one or more compounds which contain one, two or more groups of the formula II-G

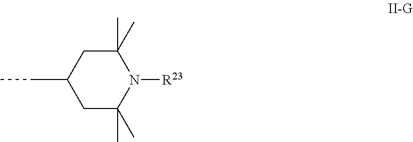

in which
R²³ denotes H or an unsubstituted alkyl radical having up to 15

C atoms, where, in addition, one or more CH₂ groups in these radicals may be replaced by —O—, —S—,

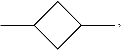

—C≡C—, —CF₂—O—, —O—CF₂—, —CO—O— or —O—CO— in such a way that O atoms are not linked directly to one another and N atoms are not linked directly either to O atoms or to S atoms.

The medium according to the invention preferably comprises one, two, three, four or more, preferably one, two or three or more, compounds of the formula I.

The total concentration of the compounds of the formula I in the media according to the invention is preferably 2% by weight or more to 40% by weight or less.

Preferred compounds of the formula I are the compounds of the formula I-1

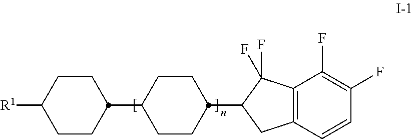

in which the parameters have the respective meanings indicated above under formula I, and particularly preferably
n denotes 0 and
R¹ denotes alkyl having 1 to 7, preferably having 1 to 5, C atoms, preferably n-alkyl.

The media according to the invention preferably comprise one or more compounds of the formula II-A, preferably one or more compounds selected from the group of the compounds of the formulae II-A-1 and II-A-2:

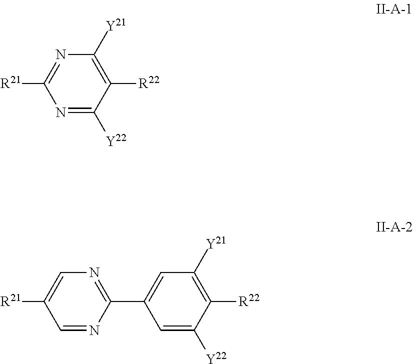

in which
Y²¹ and Y²², independently of one another, denote H or F, and
the other parameters have the respective meanings indicated above under formula II-A in claim 1.

The media according to the invention likewise preferably comprise one or more compounds selected from the group of the compounds of the formulae II-G-1 to II-G-7:

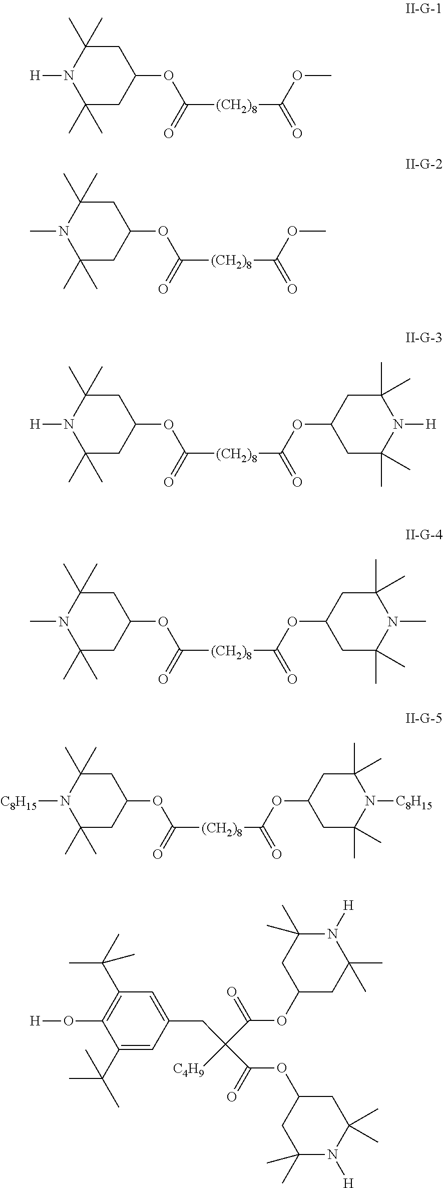

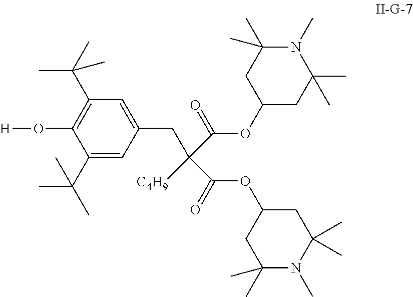

In a preferred embodiment, the media according to the invention comprise one or more compounds of the formula III

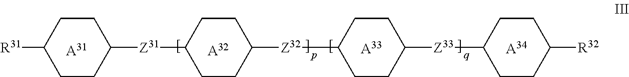

in which
R³¹ and R³² each, independently of one another, have one of the meanings given for R¹¹ and R¹² and preferably denote alkyl having 1 to 7 C atoms, preferably n-alkyl, particularly preferably n-alkyl having 1 to 5 C atoms, alkoxy having 1 to 7 C atoms, preferably n-alkoxy, particularly preferably n-alkoxy having 2 to 5 C atoms, alkoxyalkyl, alkenyl or alkenyloxy having 2 to 7 C atoms, preferably having 2 to 4 C atoms, preferably alkenyloxy,

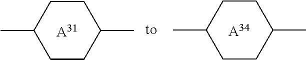

each, independently of one another, denote

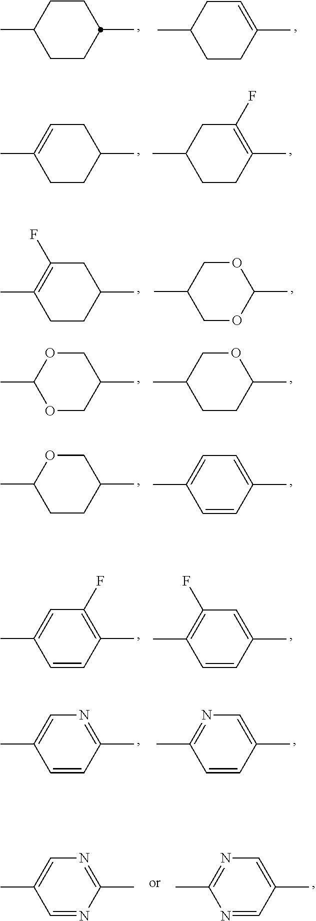

preferably

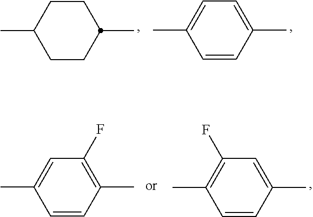

preferably

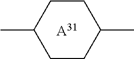

denotes

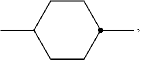

preferably

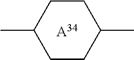

denotes

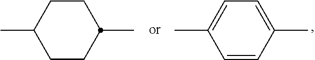

and, if present,

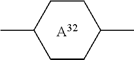

preferably denotes

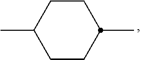

Z³¹ to Z³³ each, independently of one another, have one of the meanings given for Z¹¹ to Z¹³ and preferably denote —CH₂—CH₂—, —CH═CH—, —C≡C—, —COO— or a single bond, preferably —CH₂—CH₂— or a single bond and particularly preferably a single bond,
p and q each, independently of one another, denote 0 or 1,
(p+q) preferably denotes 0 or 1, preferably 0,
   and optionally
   one or more compounds selected from the group of the compounds of the formulae IV and V:

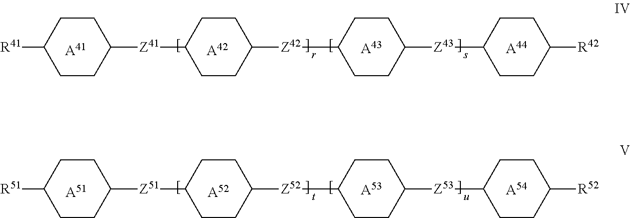

in which
R⁴¹, R⁴², R⁵¹ and R⁵² each, independently of one another, have one of the meanings given for R²¹ and R²² and preferably denote alkyl having 1 to 7 C atoms, preferably n-alkyl and particularly preferably n-alkyl having 1 to 5 C atoms, alkoxy having 1 to 7 C atoms, preferably n-alkoxy and particularly preferably n-alkoxy having 2 to 5 C atoms, or alkoxyalkyl, alkenyl or alkenyloxy having 2 to 7 C atoms, preferably having 2 to 4 C atoms, preferably alkenyloxy,
   particularly preferably one of R⁴¹ and R⁴², preferably R⁴¹, denotes an alkyl or alkenyl radical and the other denotes an alkyl, alkenyl, alkoxy or alkenyloxy radical, particularly preferably R²¹ denotes straight-chain alkyl, in particular CH₃—, C₂H₅—, n-C₃H₇—, n-C₄H₉— or n-C₅H₁₁—, or alkenyl, in particular CH₂═CH—, E-CH₃—CH═CH—, CH₂═CH—CH₂—CH₂—, E-CH₃—CH═CH—CH₂—CH₂— or E-n-C₃H₇—CH═CH—,
      one of the rings

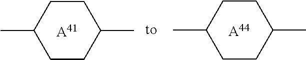

present denotes

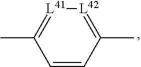

L⁴¹ and L⁴², independently of one another, denote ═C(X⁴)—, and one of L⁴¹ and L⁴² alternatively also denotes ═N—, where preferably at least one of L⁴¹ and L⁴² denotes ═C(—F)— and the other denotes ═C(—F)— or ═C(—Cl)—, particularly preferably L⁴¹ and L⁴² both denote ═C(—F)—,
X⁴ denotes F, Cl, OCF₃, CF₃, CH₃, CH₂F, CHF₂, preferably F or Cl, particularly preferably F,
   and the other rings, if present, each, independently of one another, denote

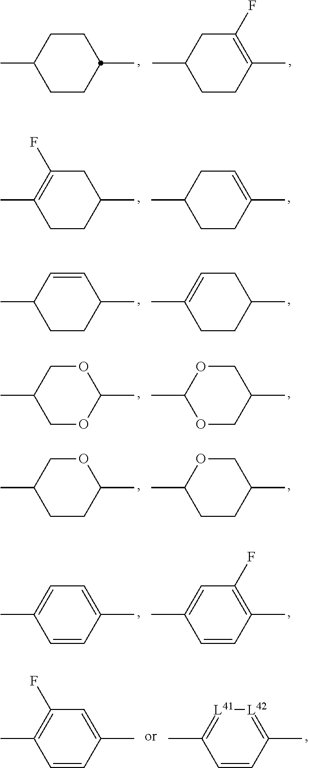

preferably

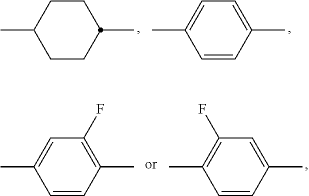

particularly preferably

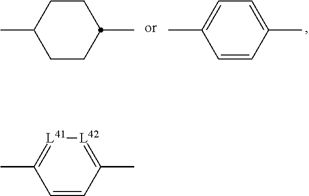

preferably denotes

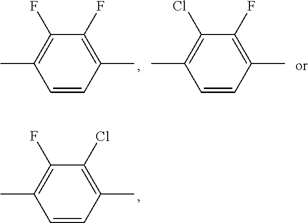

Particularly preferably

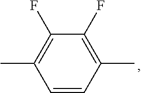

one of the rings

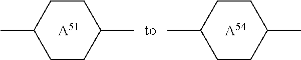

denotes

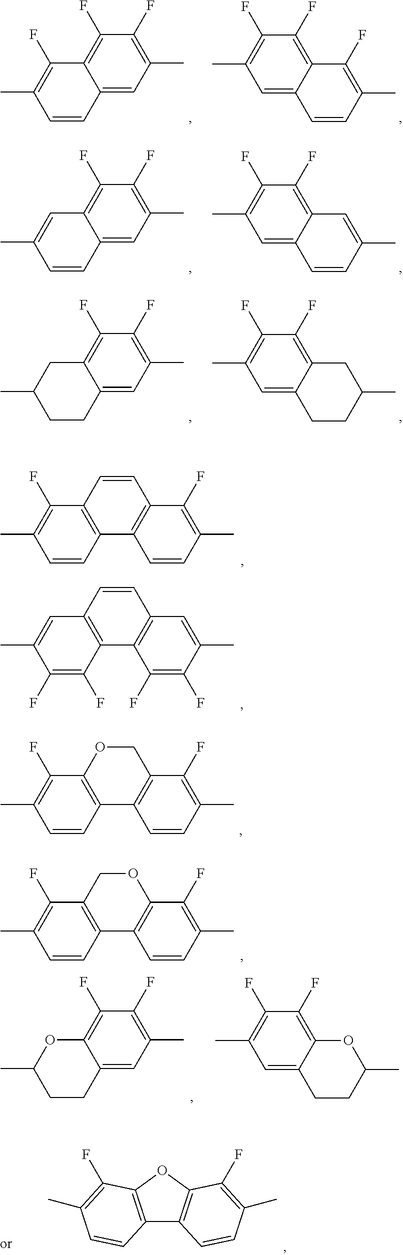

preferably

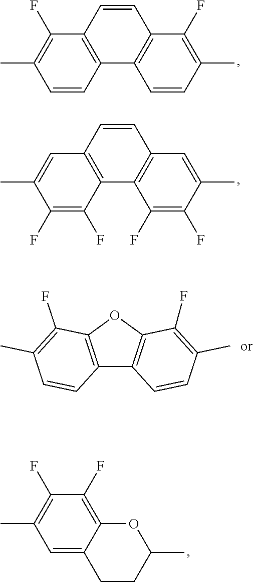

particularly preferably

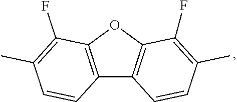

and the others, if present, each, independently of one another, denote

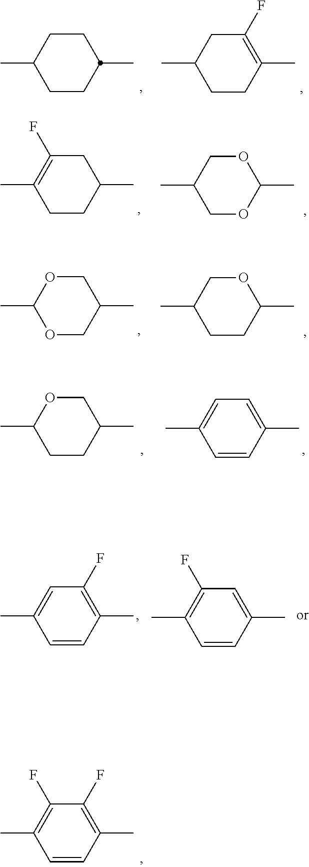

preferably

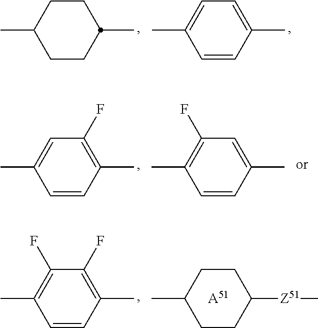

together optionally also denote a single bond,
Z⁴¹ to Z⁴³ and
Z⁵¹ to Z⁵³ each, independently of one another, have one of the meanings given for Z¹¹ to Z¹³ and preferably denote —CH₂—CH₂—, —CH₂—O—, —CH═CH—, —C≡C—, —COO— or a single bond, preferably —CH₂—CH₂—, —CH₂—O— or a single bond and particularly preferably —CH₂—O— or a single bond,
Z⁴¹ to Z⁴³ preferably each, independently of one another, denote —CH₂—CH₂—, —CH₂—CF₂—, —CF₂—CH₂—, —CF₂—CF₂—, —CH═CH—, —CF═CH—, —CH═CF—, —C≡C—, —CH₂—O—, —O—CH₂—, —O—, —CH₂—, —CO—O—, —O—CO—, —CF₂—O—, —O—CF₂— or a single bond, preferably —CH₂—CH₂—, —CH═CH—, —C≡C—, —CF₂—O—, —O—CF₂— or a single bond, particularly preferably one or, if present, more of Z⁴¹ to Z⁴³ denote a single bond, and very particularly preferably all denote a single bond,
r and s each, independently of one another, denote 0 or 1,
(r+s) preferably denotes 0 or 1,
t and u each, independently of one another, denote 0 or 1,
(t+u) preferably denotes 0 or 1, preferably 0,
   where the compounds of the formula I are the compounds of the formula V, and optionally
   one or more chiral compounds.

The media according to the invention preferably comprise the following compounds in the total concentrations stated:
10-60% by weight of one or more compounds of the formula III and/or
30-80% by weight of one or more compounds of the formulae IV and/or V,
where the total content of all compounds in the medium is 100% by weight.

The present invention also relates to electro-optical displays or electro-optical components which comprise liquid-crystalline media according to the invention. Preference is given to electro-optical displays which are based on the VA or ECB effect and in particular those which are addressed by means of an active-matrix addressing device.

Accordingly, the present invention likewise relates to the use of a liquid-crystalline medium according to the invention in an electro-optical display or in an electro-optical component, and to a process for the preparation of the liquid-crystalline media according to the invention, characterised in that one or more compounds of the formula I are mixed with one or more compounds selected from the group of the compounds of the formulae II-A to II-F and one or more compounds which contain one or more groups of the formula II-G.

In addition, the present invention relates to a process for the stabilisation of a liquid-crystalline medium which comprises one or more compounds of the formula I, characterised in that one or more compounds selected from the group of the compounds of the formulae II-A to II-F and one or more compounds which contain one or more groups of the formula II-G are added to the medium.

In a further preferred embodiment, the medium comprises one or more compounds of the formula III in which at least two of the rings

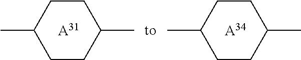

each, independently of one another, denote

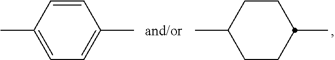

where two adjacent rings are very particularly preferably linked directly, more precisely preferably denote

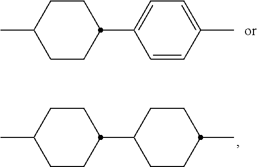

where one or more H atoms in the phenylene ring may be replaced, independently of one another, by F or CN, preferably by F, and one or two non-adjacent CH₂ groups of the cyclohexylene ring or of one of the two cyclohexylene rings may be replaced by O atoms.

In a further preferred embodiment, the medium comprises one or more compounds of the formula III from the group of the compounds of the formulae III-1 to III-11, preferably selected from the group of the compounds of the formulae III-1 to III-9, preferably from the group III-1 to III-6 and particularly preferably from the group III-1 and III-4,

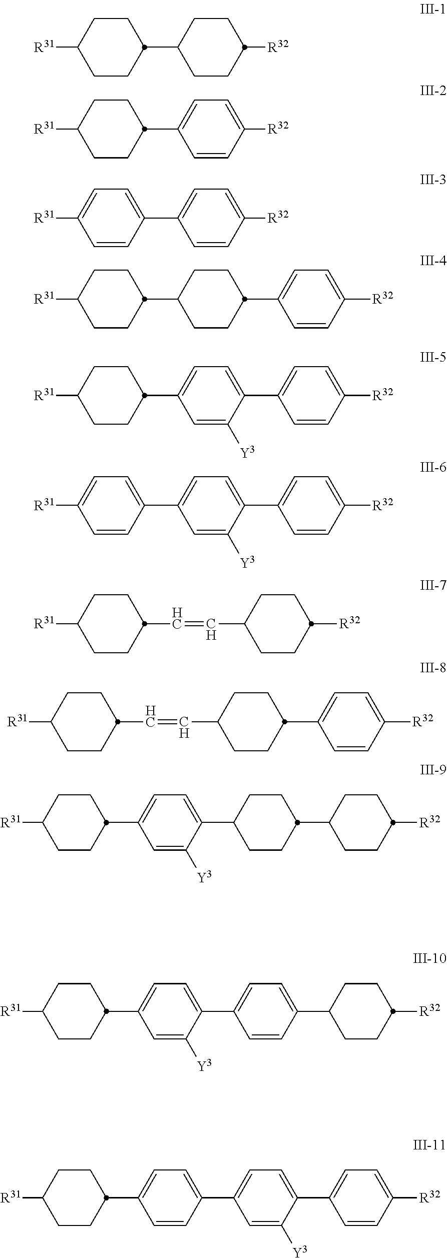

in which the parameters have the respective meanings indicated above for formula III, and
Y³ denotes H or F, and preferably
R³¹ denotes alkyl or alkenyl and
R³² denotes alkyl, alkenyl or alkoxy, preferably alkyl or alkenyl, particularly preferably alkenyl.

The medium particularly preferably comprises one or more compound(s) of the formula III-1, selected from the group
of the formula III-1c, particularly preferably
of the formula III-1 in which R³¹ denotes vinyl or 1-propenyl and R³² denotes alkyl, preferably n-alkyl, particularly preferably R³¹ denotes vinyl and R³² denotes propyl, and
of the formula III-1d, particularly preferably
of the formula III-1 in which R³¹ and R³², independently of one another, denote vinyl or 1-propenyl, R³¹ preferably denotes vinyl and R³¹ and R³² particularly preferably denote vinyl.

In a further preferred embodiment, the medium comprises one or more compounds of the formula III-1, selected from the group of the compounds of the formulae III-1a to III-1e, preferably of the formula III-1a and/or formulae III-1c and/or III-1d, particularly preferably of the formulae III-1c and/or III-1d and very particularly preferably of the formula III-1c and the formula III-1d,

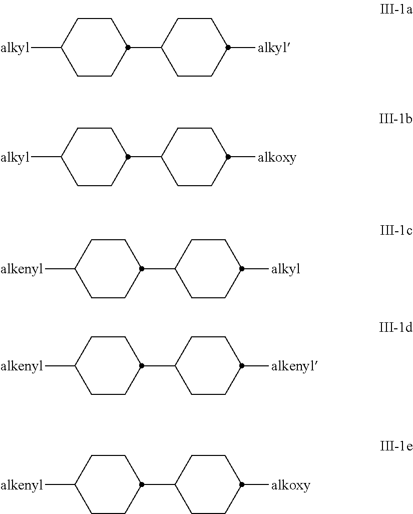

in which
alkyl and alkyl′, independently of one another, denote alkyl having 1 to 7 C atoms, preferably having 2 to 5 C atoms,
alkoxy denotes alkoxy having 1 to 5 C atoms, preferably having 2 to 4 C atoms, and
alkenyl and alkenyl', independently of one another, denote alkenyl having 2 to 7 C atoms, preferably having 2 to 5 C atoms.

The medium according to the invention particularly preferably comprises compounds of the formula III-1 in amounts of 20% by weight or more, in particular 25% by weight or more, very particularly preferably 30% by weight or more, in particular compounds of the formula III-1c′

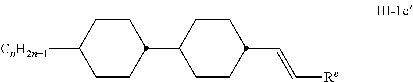

in which
n denotes 3, 4, 5 and
R^{e} denotes H or CH₃.

In a further preferred embodiment, the medium comprises one or more compounds of the formula III-1, selected from the group of the compounds of the formulae III-1a and III-1 b, preferably of the formulae III-1a and/or III-1 b, particularly preferably of the formula III-1a. The medium in this embodiment preferably comprises no compounds of the formula III, preferably of the formula III-1, containing an alkenyl end group or a plurality of alkenyl end groups, i.e. preferably no compounds of the formulae III-1c to III-1e. The medium in this embodiment particularly preferably comprises one or more compounds selected from the group of the compounds of the formulae CC-2-3, CC-2-5, CC-3-4 and CC-3-5, where the acronyms (abbreviations) are explained in Tables A to C and illustrated by examples in Table D.

In a further preferred embodiment, the medium comprises one or more compounds of the formula III-2, selected from the group of the compounds of the formulae III-2a to III-2d, preferably of the formulae III-2a and/or III-2b, particularly preferably of the formula III-2b,

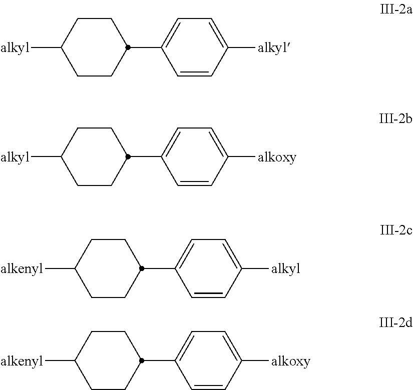

in which
alkyl and alkyl′, independently of one another, denote alkyl having 1 to 7 C atoms, preferably having 2 to 5 C atoms,
alkoxy denotes alkoxy having 1 to 5 C atoms, preferably having 2 to 4 C atoms, and
alkenyl denotes alkenyl having 2 to 7 C atoms, preferably having 2 to 5 C atoms.

In a further preferred embodiment, the medium comprises one or more compounds of the formula III-3, selected from the group of the compounds of the formulae III-3a to III-3c:

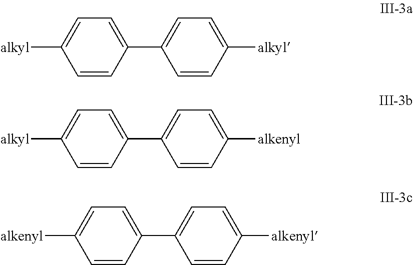

in which
alkyl and alkyl′, independently of one another, denote alkyl having 1 to 7 C atoms, preferably having 2 to 5 C atoms,
alkenyl denotes alkenyl having 2 to 7 C atoms, preferably having 2 to 5 C atoms.

The proportion of these biphenyls in the mixture as a whole is preferably 3% by weight or more, in particular 5% by weight or more.

Preferred compounds of the formulae III-3a and III-3b are the compounds of the following formulae:

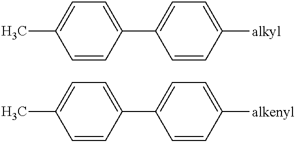

in which the parameters have the meanings indicated above.

Particularly preferred compounds of the formula III-3b are the compounds of the following formulae:

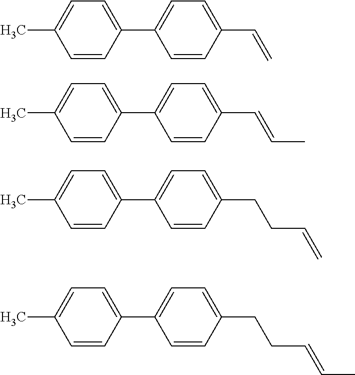

and of these in particular that of the final formula.

In a preferred embodiment, the medium comprises one or more compounds of the formula III-4, particularly preferably one or more compound(s) in which R³¹ denotes vinyl or 1-propenyl and R³² denotes alkyl, preferably n-alkyl, particularly preferably R³¹ denotes vinyl and R³² denotes methyl.

In a further preferred embodiment, the medium comprises one or more compounds of the formula III-4, selected from the group of the compounds of the formulae III-4-a to III-4-d, preferably of the formulae III-4-a and/or III-4-b, particularly preferably of the formula III-4-b,

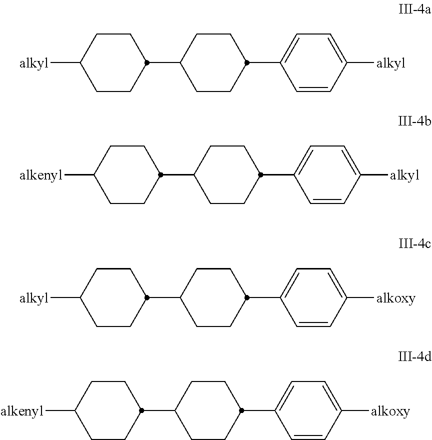

in which
alkyl and alkyl′, independently of one another, denote alkyl having 1 to 7 C atoms, preferably having 2 to 5 C atoms,
alkoxy denotes alkoxy having up to 1 to 5 C atoms, preferably having 2 to 4 C atoms, and
alkenyl denotes alkenyl having 2 to 7 C atoms, preferably having 2 to 5 C atoms.

In a preferred embodiment, the medium comprises one or more compounds of the formula III-5, particularly preferably one or more compound(s) in which R³¹ denotes alkyl, vinyl or 1-propenyl and R³² denotes alkyl, preferably n-alkyl.

In a further preferred embodiment, the medium comprises one or more compounds of the formula III-5 selected from the group of the compounds of the formulae III-5a to III-5d, preferably of the formulae III-5a and/or III-5b, particularly preferably of the formula III-5a,

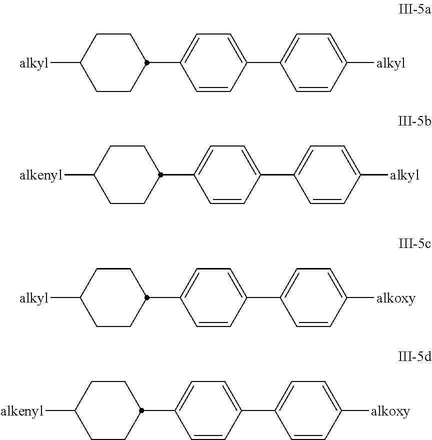

in which
alkyl and alkyl′, independently of one another, denote alkyl having 1 to 7 C atoms, preferably having 2 to 5 C atoms,
alkoxy denotes alkoxy having up to 1 to 5 C atoms, preferably having 2 to 4 C atoms, and
alkenyl denotes alkenyl having 2 to 7 C atoms, preferably having 2 to 5 C atoms,
   and/or of the formulae III-5e to III-5h, preferably of the formulae III-5e and/or III-5f, particularly preferably of the formula III-5e,

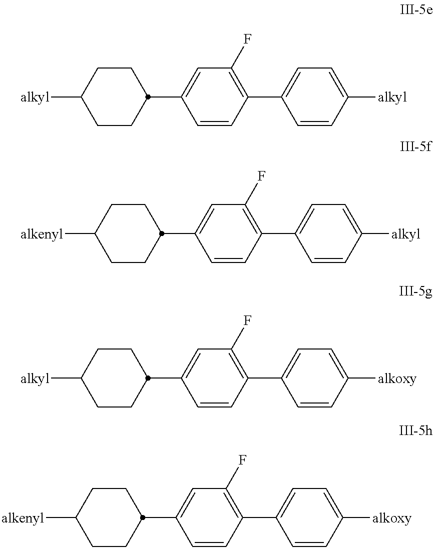

in which
alkyl and alkyl′, independently of one another, denote alkyl having 1 to 7 C atoms, preferably having 2 to 5 C atoms,
alkoxy denotes alkoxy having 1 to 5 C atoms, preferably having 2 to 4 C atoms, and
alkenyl denotes alkenyl having 2 to 7 C atoms, preferably having 2 to 5 C atoms.

In a further preferred embodiment, the medium comprises one or more compounds of the formula III-6 selected from the group of the compounds of the formulae III-6a to III-6c, preferably of the formulae III-6a and/or III-6b, particularly preferably of the formula III-6a,

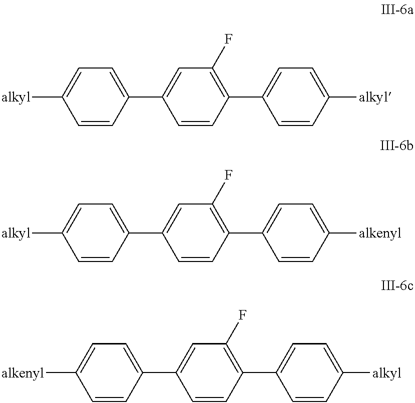

in which
alkyl and alkyl′, independently of one another, denote alkyl having 1 to 7 C atoms, preferably having 2 to 5 C atoms,
alkoxy denotes alkoxy having up to 1 to 5 C atoms, preferably having 2 to 4 C atoms, and
alkenyl denotes alkenyl having 2 to 7 C atoms, preferably having 2 to 5 C atoms.

The media according to the invention particularly preferably comprise one or more compounds selected from the compounds of the formula III-6a, preferably selected from the group of the compounds PGP-2-3, PGP-3-3 and PGP-3-4, and of the formula III-6b, preferably selected from the group of the formulae PGP-1-2V, PGP-2-2V and PGP-3-2V, where the acronyms (abbreviations) are explained in Tables A to C and illustrated by examples in Table D.

In a further preferred embodiment, the medium comprises one or more compounds of the formula III-10 selected from the group of the compounds of the formulae III-10a and III-10b:

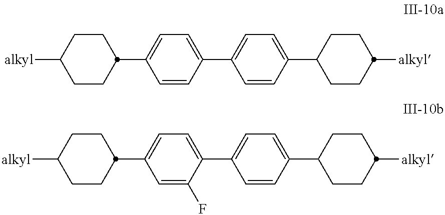

in which
alkyl and alkyl′, independently of one another, denote alkyl having 1 to 7 C atoms, preferably having 2 to 5 C atoms.

In a further preferred embodiment, the medium comprises one or more compounds of the formula III-11 selected from the compounds of the formula III-11a

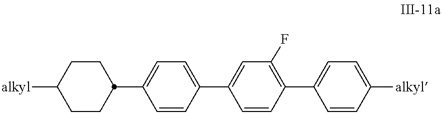

in which
alkyl and alkyl′, independently of one another, denote alkyl having 1 to 7 C atoms, preferably having 2 to 5 C atoms.

In a preferred embodiment, the medium comprises one or more compounds of the formula IV, selected from the group of the compounds of the formulae IVA to IVD, preferably IVA to IVC and very particularly preferably IVA and IVB,

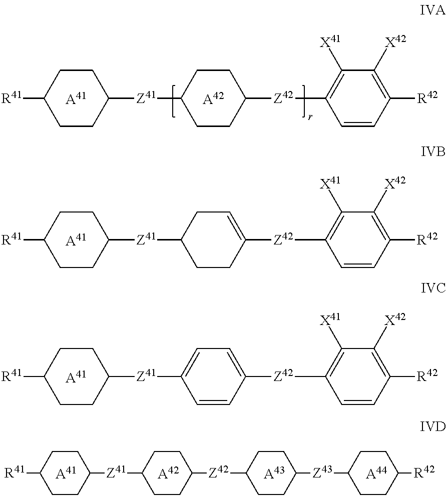

in which the parameters have the meanings indicated above, in formula IVA

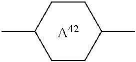

does not, however, denote

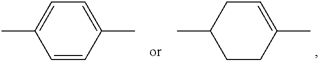

and preferably

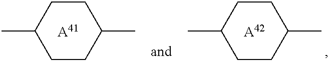

independently of one another, denote

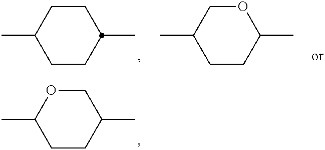

and particularly preferably

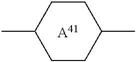

denotes

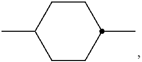

R⁴¹ denotes alkyl,
R⁴² denotes alkyl or alkoxy, particularly preferably (O)CᵥH₂ᵥ₊₁,
X⁴¹ and X⁴² both denote F,
Z²¹ and Z²², independently of one another, denote a single bond, —CH₂—CH₂—, —CH═CH—, —CH₂O—, —OCH₂—, —O—, —CH₂—, —CF₂O— or —OCF₂—, preferably a single bond or —CH₂CH₂—, particularly preferably a single bond,
p denotes 1 or 2 and
v denotes 1 to 6.

In a preferred embodiment, the medium comprises one or more compounds of the formula IV, selected from the group of the compounds of the formulae IV-1 to IV-14:

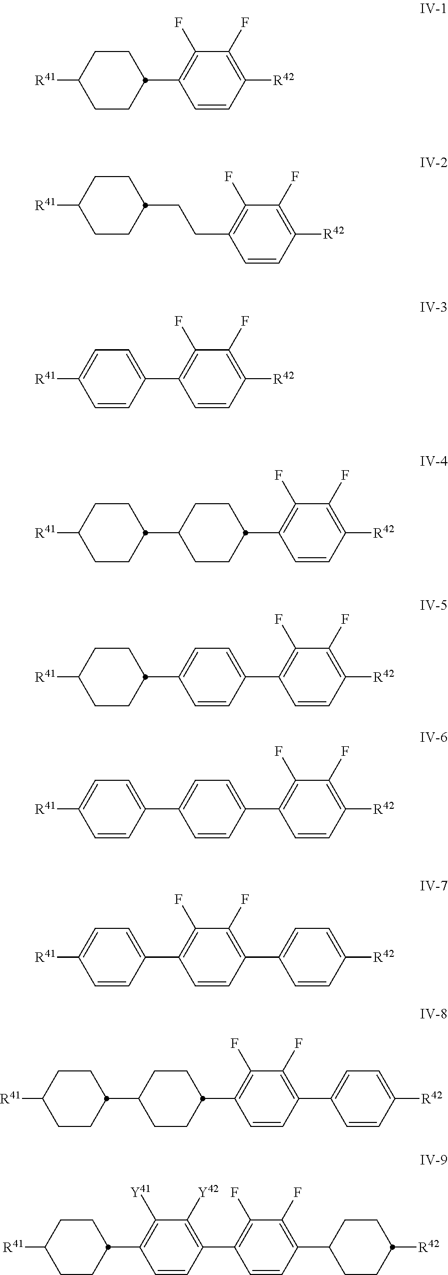

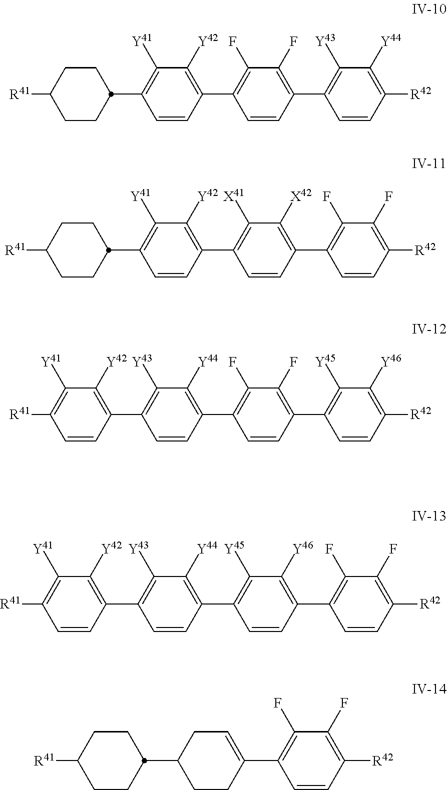

in which
Y⁴¹ to Y⁴⁶, independently of one another, denote H or F, and
X⁴¹ and X⁴² both denote H, or one of X⁴¹ and X⁴² denotes H and the other denotes F,
   but preferably at most four, particularly preferably at most three and very particularly preferably one or two, of Y⁴¹ to Y⁴⁶, X⁴¹ and X⁴² denote F,
   and
   the other parameters have the respective meanings indicated above for formula IV, and preferably
R⁴¹ denotes alkyl or alkenyl, and
R⁴² denotes alkyl, alkenyl, alkoxy or alkenyloxy, preferably (O)CᵥH₂ᵥ₊₁ and
v denotes an integer from 1 to 6.

In a further preferred embodiment, the medium comprises one or more compounds of the formula IV-1, selected from the group of the compounds of the formulae IV-1a to IV-1d, preferably of the formulae IV-1b and/or IV-1d, particularly preferably of the formula IV-1b,

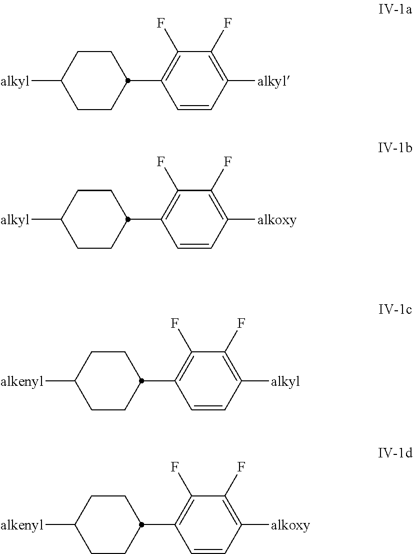

in which
alkyl and alkyl′, independently of one another, denote alkyl having 1 to 7 C atoms, preferably having 2 to 5 C atoms,
alkoxy denotes alkoxy having 1 to 7 C atoms, preferably having 2 to 4 C atoms, and
alkenyl denotes alkenyl having 2 to 7 C atoms, preferably having 2 to 5 C atoms.

Preferred compounds of the formulae IV-1c and IV-1d are the compounds of the following formulae:

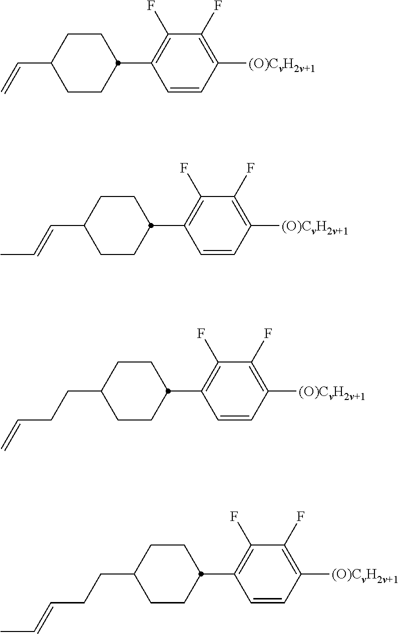

in which v has the meaning indicated above.

Further preferred compounds of the formula IV-1 are the compounds of the following formulae:

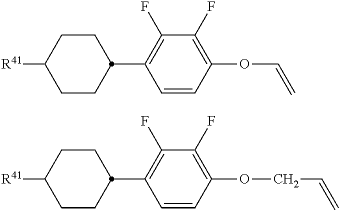

in which R⁴¹ has the respective meaning indicated above for formula IV.

In a preferred embodiment, the medium comprises one or more compounds of the formula IV-3, selected from the group of the compounds of the formulae IV-3a to IV-3d, preferably of the formulae IV-3b and/or IV-3d, particularly preferably of the formula IV-3b,

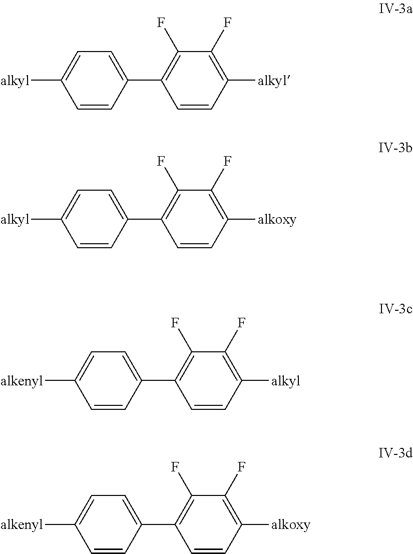

in which
alkyl and alkyl′, independently of one another, denote alkyl having 1 to 7 C atoms, preferably having 2 to 5 C atoms,
alkoxy denotes alkoxy having 1 to 7 C atoms, preferably having 2 to 4 C atoms, and
alkenyl denotes alkenyl having 2 to 7 C atoms, preferably having 2 to 5 C atoms.

The concentration of these biphenyl compounds in the mixture as a whole is preferably 3% by weight or more, in particular 5% by weight or more, and very particularly preferably from 5 to 25% by weight.

In a further preferred embodiment, the medium comprises one or more compounds of the formula IV-4, selected from the group of the compounds of the formulae IV-4-a to IV-4-d, preferably of the formulae IV-4-a and/or IV-4-b, particularly preferably of the formula IV-4-b,

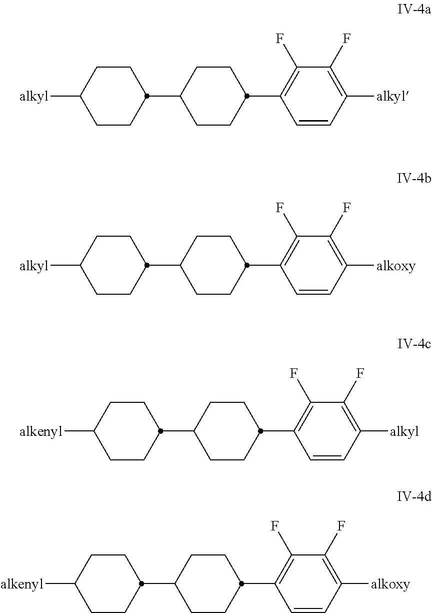

in which
alkyl and alkyl′, independently of one another, denote alkyl having 1 to 7 C atoms, preferably having 2 to 5 C atoms,
alkoxy denotes alkoxy having 1 to 7 C atoms, preferably having 2 to 4 C atoms, and
alkenyl denotes alkenyl having 2 to 7 C atoms, preferably having 2 to 5 C atoms.

Preferred compounds of the formulae IV-4-c and IV-4-d are the compounds of the following formulae:

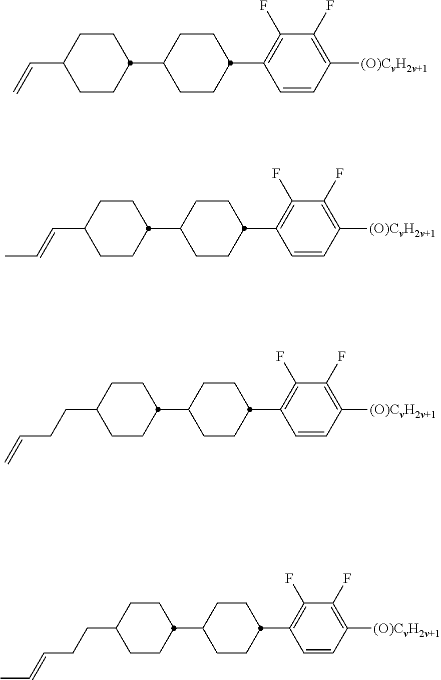

in which v has the meaning indicated above.

In a further preferred embodiment, the medium comprises one or more compounds of the formula IV-4 of the following sub-formula IV-4-e:

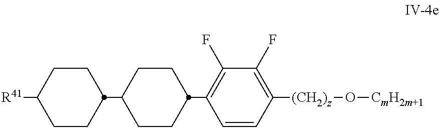

in which
R⁴¹ has the meaning indicated above, and
m and z each, independently, denote an integer from 1 to 6 and
m+z preferably denotes an integer from 1 to 6.

In a further preferred embodiment, the medium comprises one or more compounds of the formula IV-5, selected from the group of the compounds of the formulae IV-5a to IV-5d, preferably of the formulae IV-5b and/or IV-5d,

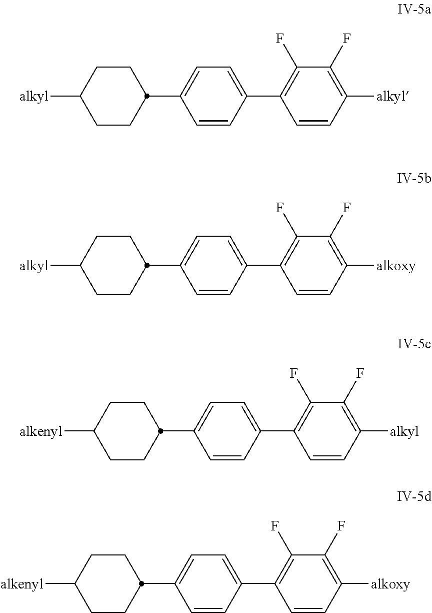

in which
alkyl and alkyl′, independently of one another, denote alkyl having 1 to 7 C atoms, preferably having 2 to 5 C atoms,
alkoxy denotes alkoxy having 1 to 7 C atoms, preferably having 2 to 4 C atoms, and
alkenyl denotes alkenyl having 2 to 7 C atoms, preferably having 2 to 5 C atoms.

Preferred compounds of the formulae IV-5c and IV-5d are the compounds of the following formulae:

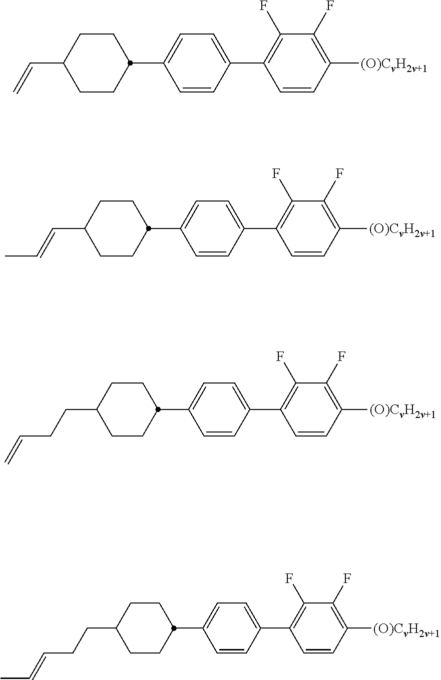

in which v has the meaning indicated above.

In a further preferred embodiment, the medium comprises one or more compounds of the formula IV-6, selected from the group of the compounds of the formulae IV-6a to IV-6d, preferably of the formulae IV-6a and/or IV-6c, particularly preferably of the formula IV-6a,

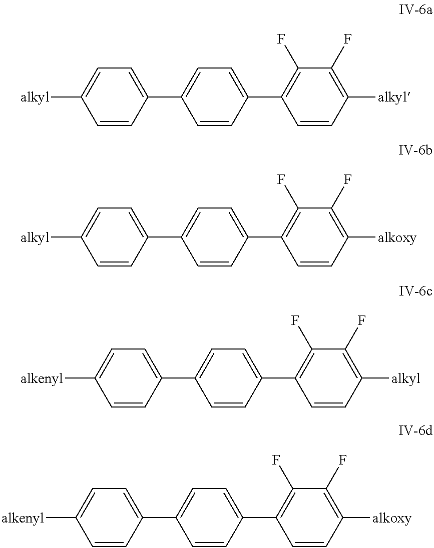

in which
alkyl and alkyl′, independently of one another, denote alkyl having 1 to 7 C atoms, preferably having 2 to 5 C atoms,
alkoxy denotes alkoxy having up to 1 to 7 C atoms, preferably having 2 to 4 C atoms, and
alkenyl denotes alkenyl having 2 to 7 C atoms, preferably having 2 to 5 C atoms,
   and/or the group of the compounds of the formulae IV-6e to IV-6m:

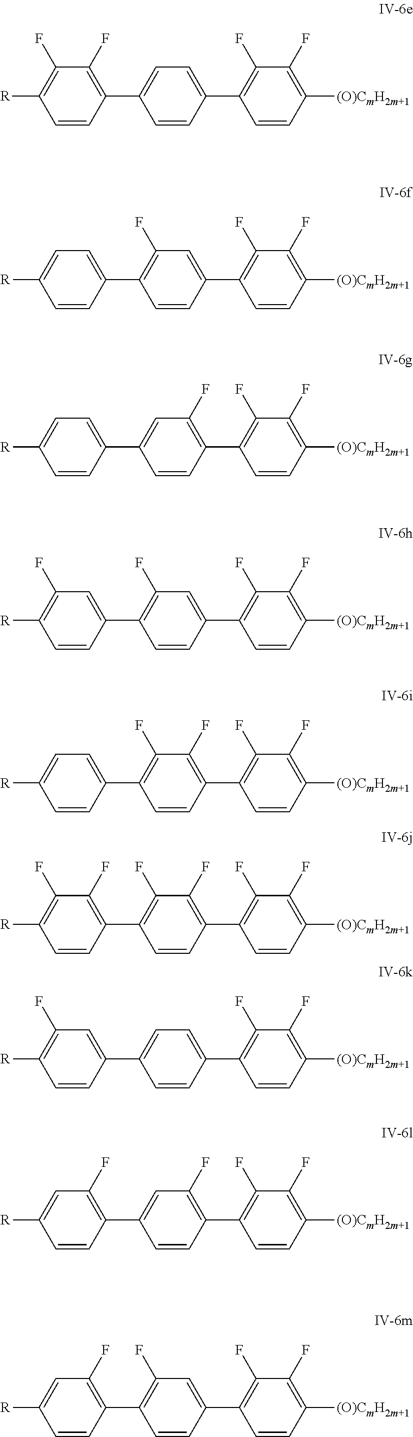

in which
R has the meaning given above for R⁴¹ and
m denotes an integer from 1 to 6.

R preferably denotes straight-chain alkyl or alkoxy, each having 1 to 6 C atoms, or alkylalkoxy, alkenyl or alkenyloxy having 2-6 C atoms, particularly preferably alkyl having 1-5 C atoms, preferably methyl, ethyl, propyl, butyl, or furthermore alkoxy having 1-5 C atoms, preferably hexyl, methoxy, ethoxy, propoxy or butoxy.

In a further preferred embodiment, the medium comprises one or more compounds of the formula IV-7, selected from the group of the compounds of the formulae IV-7a to IV-7d, preferably of the formulae IV-7a and/or IV-7c, particularly preferably of the formula IV-7a,

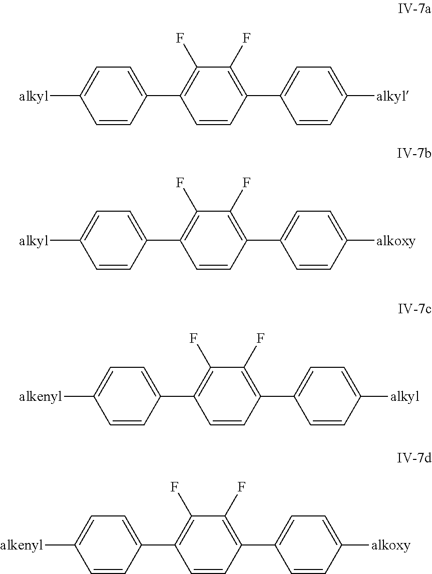

in which
alkyl and alkyl′, independently of one another, denote alkyl having 1 to 7 C atoms, preferably having 2 to 5 C atoms,
alkoxy denotes alkoxy having up to 1 to 5 C atoms, preferably having 2 to 4 C atoms, and
alkenyl denotes alkenyl having 2 to 7 C atoms, preferably having 2 to 5 C atoms,
   and/or the group of the compounds of the formulae IV-7e to IV-71:

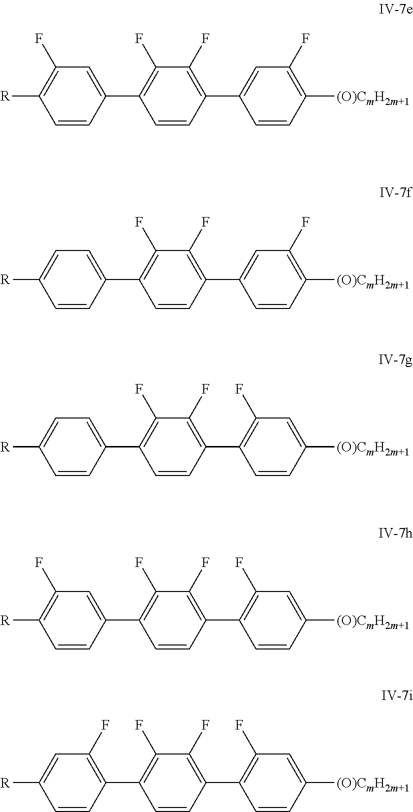

in which
R has the meaning given above for R⁴¹ and
m denotes an integer from 1 to 6.

R preferably denotes straight-chain alkyl or alkoxy, each having 1 to 6 C atoms, or alkylalkoxy, alkenyl or alkenyloxy having 2-6 C atoms, particularly preferably alkyl having 1-5 C atoms, preferably methyl, ethyl, propyl, butyl, or furthermore alkoxy having 1-5 C atoms, preferably hexyl, methoxy, ethoxy, propoxy or butoxy.

In a further preferred embodiment, the medium comprises one or more compounds of the formula IV-8, selected from the group of the compounds of the formulae IV-8a and IV-8b, particularly preferably IV-8b,

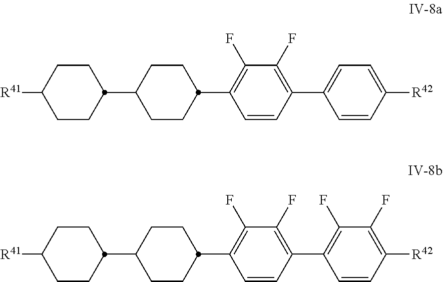

in which the parameters have the meanings indicated above.

In a further preferred embodiment, the medium comprises one or more compounds of the formula IV-9, selected from the group of the compounds of the formulae IV-9a to IV-9d:

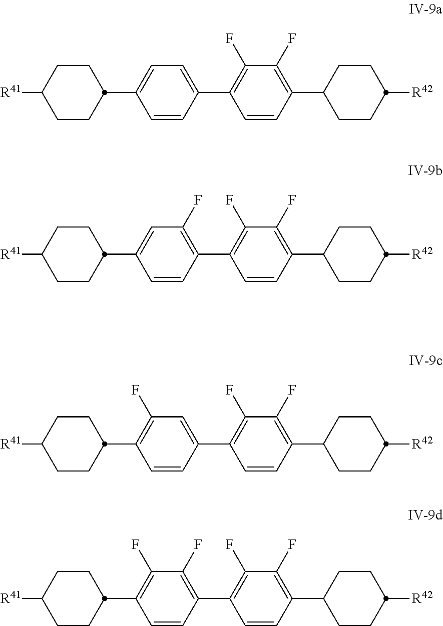

in which the parameters have the meanings indicated above, and preferably
R⁴² denotes CᵥH₂ᵥ₊₁ and
v denotes an integer from 1 to 6.

In a further preferred embodiment, the medium comprises one or more compounds of the formula IV-10, selected from the group of the compounds of the formulae IV-10a to IV-10e:

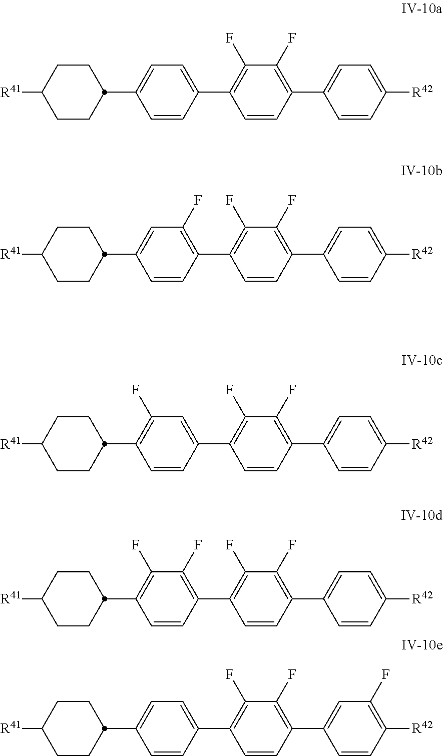

in which the parameters have the meanings indicated above, and preferably
R⁴² denotes CᵥH₂ᵥ₊₁ and
v denotes an integer from 1 to 6.

In a further preferred embodiment, the medium comprises one or more compounds of the formula IV-11, selected from the group of the compounds of the formulae IV-11a and IV-11b, particularly preferably IV-11b,

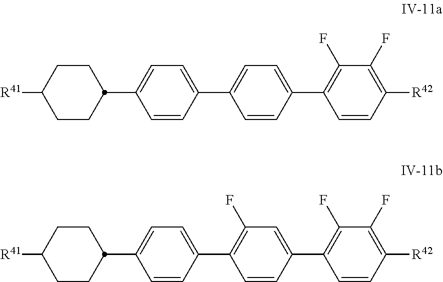

in which the parameters have the meanings indicated above.

In a further preferred embodiment, the medium comprises one or more compounds of the formula IV-14, selected from the group of the compounds of the formulae IV-14a to IV-14d, preferably of the formulae IV-14a and/or IV-14b, particularly preferably of the formula IV-14b,

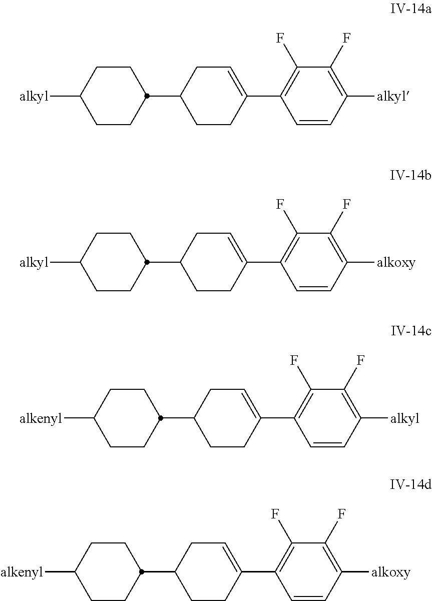

in which
alkyl and alkyl′, independently of one another, denote alkyl having 1 to 7 C atoms, preferably having 2 to 5 C atoms,
alkoxy denotes alkoxy having 1 to 7 C atoms, preferably having 2 to 4 C atoms, and
alkenyl denotes alkenyl having 2 to 7 C atoms, preferably having 2 to 5 C atoms.

In a further preferred embodiment, the medium (additionally) comprises one or more compounds of the formula V, preferably selected from the group of the compounds of the formulae V-1 to V-8, preferably of the formulae V-7 and/or V-8,

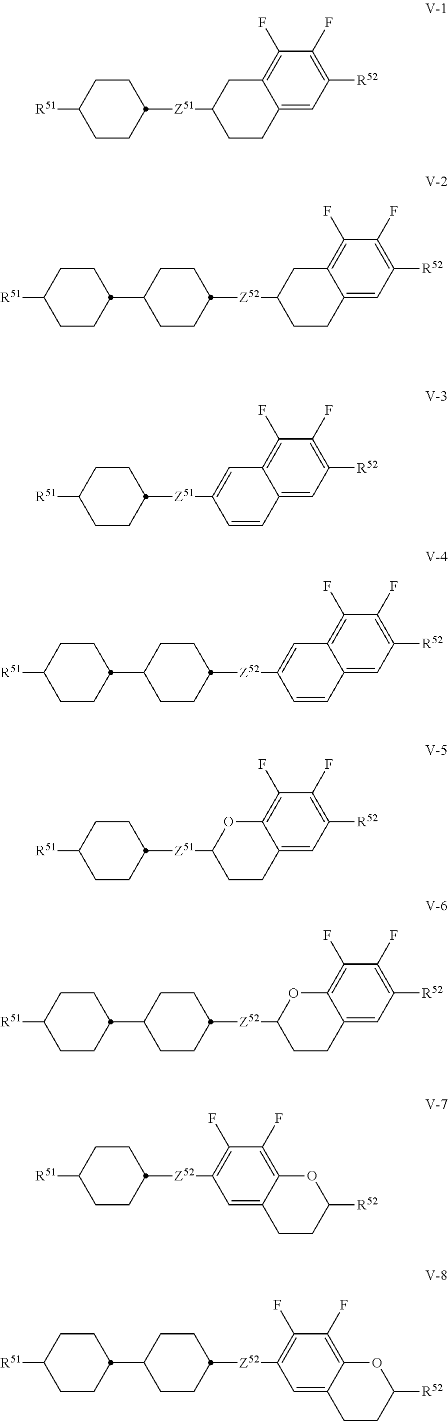

in which the parameters have the respective meanings indicated above for formula V, and preferably
R⁵¹ denotes alkyl or alkenyl and
R⁵² denotes alkyl, alkenyl, alkoxy or alkenyloxy.

In a further preferred embodiment, the medium (additionally) comprises one or more compounds which contain a fluorinated phenanthrene unit, preferably compounds of the formula V, preferably selected from the group of the compounds of the formulae V-9 and V-10:

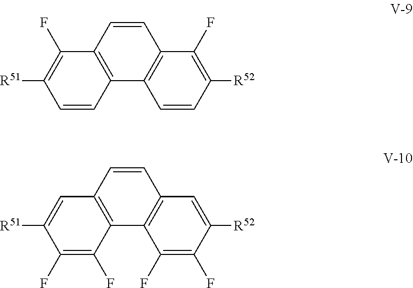

in which the parameters have the respective meanings indicated above for formula V, and preferably
R⁵¹ denotes alkyl or alkenyl and
R⁵² denotes alkyl, alkenyl, alkoxy or alkenyloxy.

In a further preferred embodiment, the medium (additionally) comprises one or more compounds which contain a fluorinated dibenzofuran unit, preferably compounds of the formula V, preferably of the formula V-11,

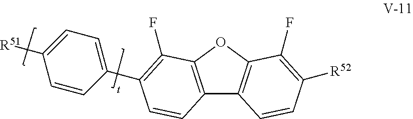

in which the parameters have the respective meanings indicated above for formula V, and preferably
R⁵¹ denotes alkyl or alkenyl and
R⁵² denotes alkyl, alkenyl, alkoxy or alkenyloxy.

The medium particularly preferably (additionally) comprises one or more compounds which contain a trifluorinated naphthalenediyl unit, preferably compounds of the formula V, preferably selected from the group of the formulae V-12 to V-15:

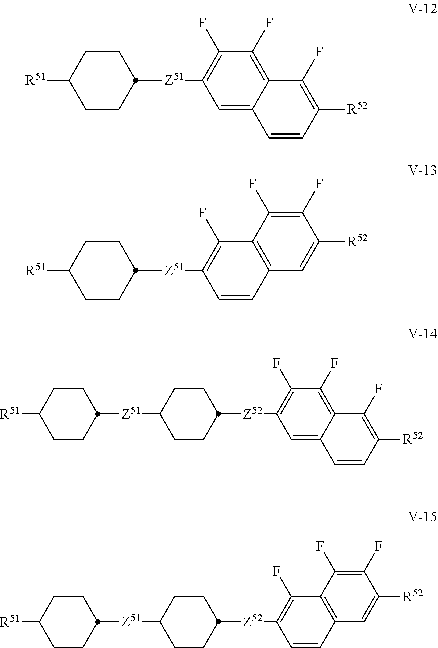

in which the parameters have the respective meanings given above under formula V, and preferably
in formulae V-12 and V-13
Z⁵¹ denotes —CH₂—CH₂—, —CH₂—O— or a single bond, preferably —CH₂—O— or a single bond, particularly preferably —CH₂—O—,
   in formulae V-14 and V-15
Z⁵¹ denotes —CH₂—CH₂— or a single bond, preferably a single bond, and
Z⁵² denotes —CH₂—CH₂—, —CH₂—O— or a single bond, preferably —CH₂—O— or a single bond, particularly preferably —CH₂—O—.

Very particular preference is given to the following compounds, the compounds of the formulae V-12a, V-12b, V-14a and V-14b:

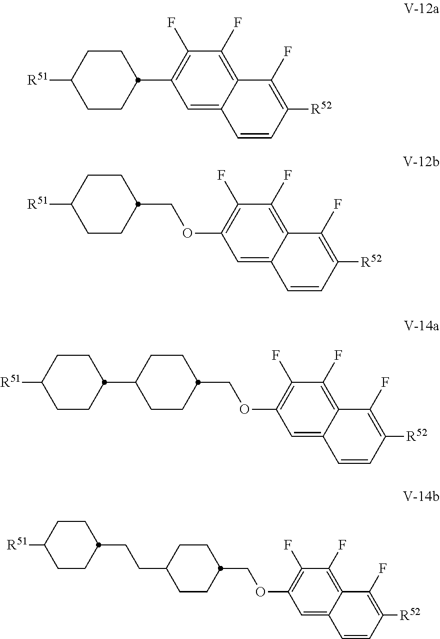

in which the parameters have the meanings given above, and R⁵¹ preferably denotes alkyl having 1 to 7, preferably having 1 to 5, C atoms, preferably n-alkyl, and R⁵² preferably denotes alkoxy having 1 to 5, preferably having 2 to 4, C atoms.

The chiral compound or the chiral compounds which can be used in the liquid-crystal media in accordance with the present invention are preferably selected from the known chiral dopants. Component E preferably consists predominantly, particularly preferably essentially and very particularly preferably virtually completely of one or more compounds selected from the group of the compounds of the following formulae VI to VIII:

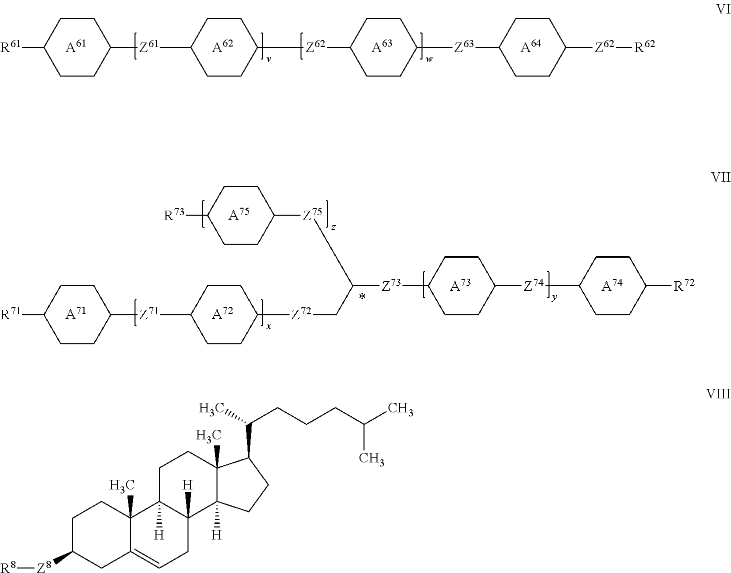

in which
R⁶¹ and R⁶², R⁷¹ to R⁷³ and R⁸ each, independently of one another, have the meanings given above for R²¹ under formula II and alternatively denote H, CN, F, Cl, CF₃, OCF₃, CF₂H or OCF₂H, and at least one of R⁶¹ and R⁶² denotes a chiral group,
Z⁶¹ and Z⁶², Z⁷¹ to Z⁷³ and Z⁸ each, independently of one another, denote —CH₂CH₂—, —CH═CH—, —COO—, —O—CO— or a single bond, preferably Z⁶¹, Z⁶², Z⁷¹, Z⁷⁴ and Z⁷⁵ denote a single bond, Z⁶³, Z⁷² and Z⁷³ denote —COO— or a single bond, Z⁷² preferably denotes —COO—, and Z⁷³ and Z⁸ denote —O—CO—,

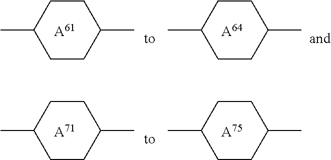

each, independently of one another, denote

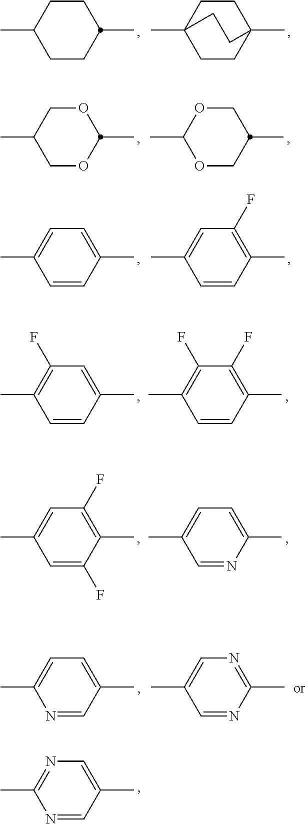

u and v, and
x, y and z each, independently of one another, denote 0 or 1, preferably
u and v both denote 0 and
x and v both denote 1.

Particularly preferred embodiments of the present invention satisfy one or more of the following conditions:
i. The liquid-crystalline medium has a birefringence of 0.090 or more.
ii. The liquid-crystalline medium comprises one or more compounds of the sub-formula I-1.
iii. The concentrations of the individual homologous compounds of the formula I are in the range from 1 to 20%, preferably from 2 to 15% and particularly preferably from 3 to 10%.
iv. The total concentration of the compounds of the formulae II-A to II-F in the mixture as a whole is 0.1% by weight or less.
v. The total concentration of the compounds which contain one or more groups of the formula II-G in the mixture as a whole is 0.1% by weight or less.
vi. The concentrations of the individual homologous compounds of the formula I are in the range from 2 to 15%, preferably from 3 to 12% and particularly preferably from 4 to 10%.
vii. The proportion of compounds of the formula III in the mixture as a whole is 10% or more, preferably 70% or less and particularly preferably 20% by weight or more.
viii. The liquid-crystalline medium comprises one or more particularly preferred compounds of the formulae III-1c and III-1d selected from the sub-formulae mentioned below:

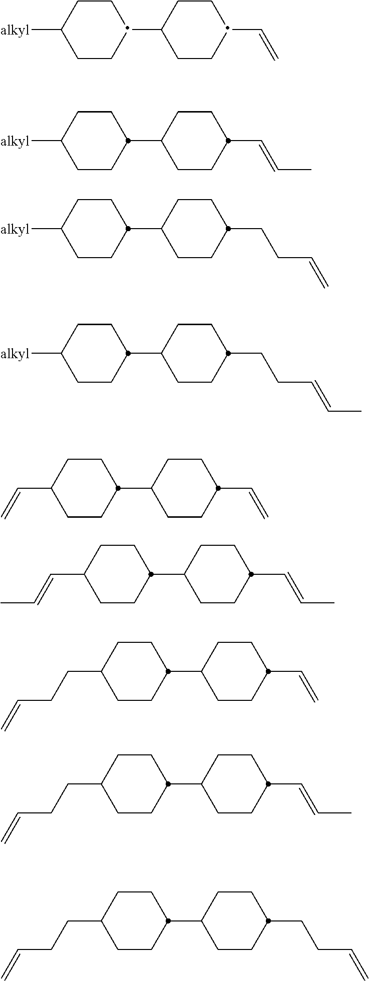

in which alkyl has the meaning given above and preferably in each case, independently of one another, denotes alkyl having 1 to 6, preferably having 2 to 5, C atoms and particularly preferably n-alkyl.
ix. The liquid-crystalline medium comprises one or more compounds of the formula III selected from the group of the following formulae:

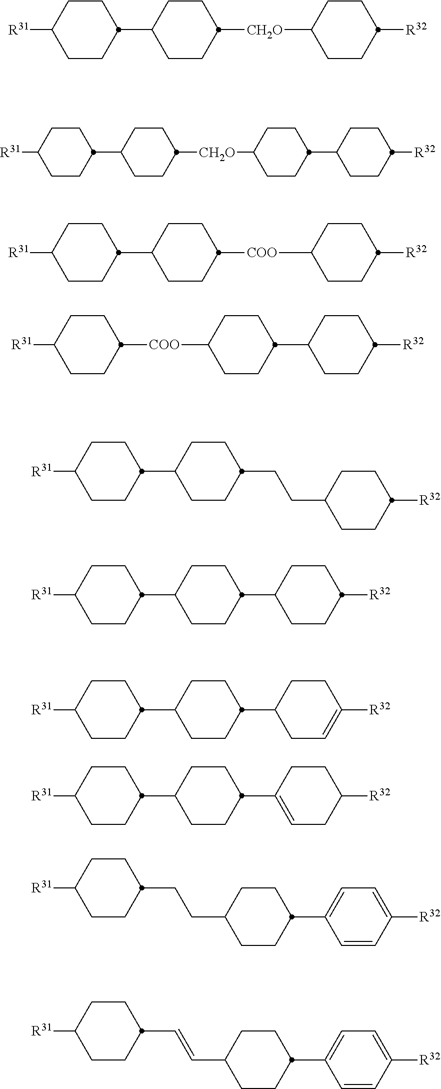

in which R³¹ and R³² have the meanings indicated above, and R³¹ and R³² preferably each, independently of one another, denote a straight-chain alkyl, alkoxy or alkenyl radical having 1 or 2 to 7 C atoms respectively, particularly preferably straight-chain alkyl, furthermore alkenyl.

The proportion of these compounds in the mixture is preferably 5 to 40% by weight.
x. The liquid-crystalline medium comprises one or more compounds of the formula III selected from the group of the compounds of the following formulae: CC-n-V and/or CC-n-Vm (for example: preferably CC-5-V, preferably in a concentration of up to 25% or less, CC-3-V, preferably in a concentration of up to 60% or less, and/or CC-3-V1, preferably in a concentration of up to 25% or less, and/or CC-4-V, preferably in a concentration of up to 40% or less), CC-n-m and/or CC-n-Om (for example: preferably CC-3-2 and/or CC-3-3 and/or CC-3-4 and/or CC-3-O2 and/or CCP-5-O₂), CP-n-m and/or CP-n-Om (for example: preferably CP-3-2 and/or CP-5-2 and/or CP-3-01 and/or CP-3-O₂), PP-n-Vm (for example: preferably PP-n-2V), PP-n-IVm (for example: preferably PP-n-2V1), CCP-n-m (for example: preferably CCP-n-1), CPP-n-m, CGP-n-m and CCOC-n-m, in which the meanings of the acronyms (abbreviations) are explained in Tables A to C and illustrated by examples in Table D, preferably in a total concentration of up to 10% or more to 70% or less.
xi. The liquid-crystalline medium essentially consists of
   2% by weight to 80% by weight of one or more compounds of the formula I,
   5.0·10⁻³% by weight to 1.0% by weight of one or more compounds selected from the group of the compounds of the formulae II-A to II-F,
   5.0·10⁻⁴% by weight to 1.0% by weight of one or more compounds which contain one, two or more groups of the formula II-G,
   2% by weight to 80% by weight of one or more compounds of the formula III, and/or
   2% by weight to 80% by weight of one or more compounds selected from the group of the compounds of the formulae IV and/or V.
xii. The liquid-crystalline medium comprises one or more compounds of the formula IV, preferably in amounts of 2% by weight or more, in particular 5% by weight or more, and very particularly preferably from 5% by weight or more to 25% by weight or less, in particular in the range from 2% by weight or more to 12% by weight or less, per homologous individual compound.
xiii. The liquid-crystalline medium comprises one or more compounds of the formulae IV-1 to IV-3, preferably IV-1 and/or IV-3, preferably of the formulae IV-1b and/or IV-1d and/or IV-3b and/or IV-3d, particularly preferably IV-1b and/or IV-3b, preferably in a total concentration of 60% or less and in a concentration of 2% by weight or more, in particular 5% by weight or more, and very particularly preferably from 5% by weight or more to 20% by weight or less, per homologous individual compound.
xiv. The liquid-crystalline medium comprises one or more compounds of the formulae IV-4 and/or IV-5, preferably of the formulae IV-4b and/or IV-4d and/or IV-5b and/or IV-5d, particularly preferably IV-4b and/or IV-5b, preferably in a total concentration of 60% or less and in a concentration of 2% by weight or more, in particular 5% by weight or more, and very particularly preferably from 5% by weight or more to 20% by weight or less, per homologous individual compound.
xv. The liquid-crystalline medium comprises one or more compounds of the formulae IV-6 and/or IV-7, preferably of the formulae IV-6a and/or IV-7a, preferably in a total concentration of 50% or less and preferably in a concentration of 2% by weight or more to 10% by weight or less per homologous individual compound of the formula IV-6 and in a concentration of 2% by weight or more to 20% by weight or less per homologous individual compound of the formula IV-6.
xvi. The liquid-crystalline medium comprises one or more compounds of the formula IV, preferably in amounts of 2% by weight or more, in particular 5% by weight or more, and very particularly preferably from 5% by weight to 25% by weight, in particular in the range from 2% by weight to 12% by weight, per individual compound.
xvii. The liquid-crystalline medium comprises one or more compounds of the formula V, preferably in amounts of 3% by weight or more, in particular 5% by weight or more, and very particularly preferably from 5% by weight to 25% by weight, in particular in the range from 2% by weight to 20% by weight, per individual compound.

The invention furthermore relates to an electro-optical display having active-matrix addressing based on the VA or ECB effect, characterised in that it contains, as dielectric, a liquid-crystalline medium according to the present invention.

The liquid-crystal mixture preferably has a nematic phase range having a width of at least 60 degrees and a flow viscosity v₂₀ of at most 30 mm²·s⁻¹ at 20° C.

The liquid-crystal mixture according to the invention has a Δ∈ of about −0.5 to −8.0, in particular about −2.5 to −6.0, where Δ∈ denotes the dielectric anisotropy. The rotational viscosity γ₁ is preferably 200 mPa·s or less, in particular 170 mPa·s or less.

The birefringence Δn in the liquid-crystal mixture is generally between 0.06 and 0.16, preferably between 0.08 and 0.14.

The mixtures according to the invention are suitable for all VA-TFT applications, such as, for example, VAN, MVA, (S)-PVA and ASV. They are furthermore suitable for IPS (in-plane switching), FFS (fringe field switching) and PALC applications of negative Δ∈.

The nematic liquid-crystal mixtures in the displays according to the invention generally comprise two components A and B, which themselves consist of one or more individual compounds.

The liquid-crystalline media according to the invention preferably comprise 4 to 15, in particular 5 to 12, and particularly preferably 10 or less, compounds. These are preferably selected from the group of the compounds of the formulae I, II-A to II-F, the compounds which contain one or more groups of the formula II-G, of the formulae III and/or IV and/or V.

The liquid-crystalline media according to the invention may optionally also comprise more than 18 compounds. In this case, they preferably comprise 18 to 25 compounds.

Besides compounds of the formulae I to V and optionally of the formulae VI to VIII, other constituents may also be present, for example in an amount of up to 45% of the mixture as a whole, but preferably up to 35%, in particular up to 10%.

The other constituents are preferably selected from nematic or nematogenic substances, in particular known substances, from the classes of the azoxybenzenes, benzylideneanilines, biphenyls, terphenyls, phenyl or cyclohexyl benzoates, phenyl or cyclohexyl cyclo hexanecarboxylates, phenylcyclohexanes, cyclohexylbiphenyls, cyclohexylcyclohexanes, cyclohexylnaphthalenes, 1,4-biscyclohexylbiphenyls or cyclohexylpyrimidines, phenyl- or cyclohexyldioxanes, optionally halogenated stilbenes, benzyl phenyl ethers, tolans and substituted cinnamic acid esters.

The most important compounds which are suitable as constituents of liquid-crystal phases of this type can be characterised by the formula IX

R⁹¹-L-G-E-R⁹² IX

in which L and E each denote a carbo- or heterocyclic ring system from the group formed by 1,4-disubstituted benzene and cyclohexane rings, 4,4′-disubstituted biphenyl, phenylcyclohexane and cyclohexylcyclohexane systems, 2,5-disubstituted pyrimidine and 1,3-dioxane rings, 2,6-disubstituted naphthalene, di- and tetrahydronaphthalene, quinazoline and tetrahydroquinazoline,

| | | |
|---|---|---|
| G denotes | —CH═CH— | —N(O)═N— |
| | —CH—CQ— | —CH═N(O)— |
| | —C≡C— | —CH₂—CH₂— |
| | —CO—O— | —CH₂—O— |
| | —CO—S— | —CH₂—S— |
| | —CH═N— | —COO-Phe-COO— |
| | —CF₂O— | —CF═CF— |
| | —OCF₂— | —OCH₂— |
| | —(CH₂)₄— | —(CH₂)₃O— |

or a C—C single bond, Q denotes halogen, preferably chlorine, or —CN, and R⁹¹ and R⁹² each denote alkyl, alkenyl, alkoxy, alkanoyloxy or alkoxycarbonyloxy having up to 18, preferably up to 8, carbon atoms, or one of these radicals alternatively denotes CN, NC, NO₂, NCS, CF₃, OCF₃, F, Cl or Br.

In most of these compounds, R⁹¹ and R⁹² are different from one another, one of these radicals usually being an alkyl or alkoxy group. Other variants of the proposed substituents are also common. Many such substances or also mixtures thereof are commercially available. All these substances can be prepared by methods known from the literature.

The concentration of the compounds of the formula IX in the mixture as a whole is preferably 1% to 25%, particularly preferably 1% to 15% and very particularly preferably 2% to 9%.

The media according to the invention may optionally also comprise a dielectrically positive component, whose total concentration is preferably 10% by weight or less, based on the entire medium.

In a preferred embodiment, the liquid-crystal media according to the invention comprise in total, based on the mixture as a whole, 5% or more to 60% or less, preferably 10% or more to 50% or less, preferably 15% or more to 40% or less and particularly preferably 20% or more to 35% or less and very particularly preferably 25% or more to 30% or less of compounds of the formula I and

1% or more to 45% or less, preferably 2% or more to 40% or less, preferably 3% or more to 35% or less and particularly preferably 5% or more to 30% or less and very particularly preferably 10% or more to 20% or less of compounds of the formula III and
5% or more to 80% or less, preferably 25% or more to 75% or less, particularly preferably 35% or more to 70% or less and very particularly preferably 40% or more to 65% or less of compounds of the formulae IV and/or V.

The respective different preferred ranges of the concentrations of the compounds of the respective different formulae can be combined as desired with one another, but the total concentration of all compounds in the media does not exceed 100% in each case.

In a preferred embodiment, the liquid-crystal media according to the invention comprise compounds selected from the group of the compounds of the formulae I, II-A to II-F, II-G and III to V, preferably consist predominantly, particularly preferably essentially and very particularly preferably virtually completely of the compounds of the said formulae.

The liquid-crystal media according to the invention preferably have a nematic phase from in each case at least −20° C. or less to 70° C. or more, particularly preferably from −30° C. or less to 80° C. or more, very particularly preferably from −40° C. or less to 85° C. or more and most preferably from −40° C. or less to 90° C. or more.

The expression “have a nematic phase” here means on the one hand that no smectic phase and no crystallisation are observed at low temperatures at the corresponding temperature and on the other hand that no clearing occurs on heating out of the nematic phase. The investigation at low temperatures is carried out in a flow viscometer at the corresponding temperature and checked by storage in test cells having a cell thickness corresponding to the electro-optical application for at least 100 hours. If the storage stability at a temperature of −20° C. in a corresponding test cell is 1000 h or more, the medium is regarded as stable at this temperature. At temperatures of −30° C. and −40° C., the corresponding times are 500 h and 250 h respectively. At high temperatures, the clearing point is measured in capillaries by conventional methods.

In a preferred embodiment, the liquid-crystal media according to the invention are characterised by optical anisotropy values in the moderate to low region. The birefringence values are preferably in the range from 0.065 or more to 0.130 or less, particularly preferably in the range from 0.080 or more to 0.120 or less and very particularly preferably in the range from 0.085 or more to 0.110 or less.

In this embodiment, the liquid-crystal media according to the invention have negative dielectric anisotropy and have relatively high absolute values of the dielectric anisotropy (|Δ∈|) which are preferably in the range from 2.7 or more to 5.3 or less, preferably to 4.5 or less, preferably from 2.9 or more to 4.5 or less, particularly preferably from 3.0 or more to 4.0 or less and very particularly preferably from 3.5 or more to 3.9 or less.

The liquid-crystal media according to the invention have relatively low values for the threshold voltage (V₀) in the range from 1.7 V or more to 2.5 V or less, preferably from 1.8 V or more to 2.4 V or less, particularly preferably from 1.9 V or more to 2.3 V or less and very particularly preferably from 1.95 V or more to 2.1 V or less.

In a further preferred embodiment, the liquid-crystal media according to the invention preferably have relatively low values of the average dielectric anisotropy (∈_{av.}≡(∈_{∥}+2∈_{⊥})/3) which are preferably in the range from 5.0 or more to 7.0 or less, preferably from 5.5 or more to 6.5 or less, still more preferably from 5.7 or more to 6.4 or less, particularly preferably from 5.8 or more to 6.2 or less and very particularly preferably from 5.9 or more to 6.1 or less.

In a preferred embodiment, which is particularly suitable for use in LCD TV displays, the liquid-crystal media according to the invention have absolute values of the dielectric anisotropy (|Δ∈|) which are preferably in the range from 1.7 or more to 4.9 or less, preferably to 4.3 or less, preferably from 2.3 or more to 4.0 or less, particularly preferably from 2.8 or more to 3.8 or less.

In this embodiment, the liquid-crystal media according to the invention have values for the threshold voltage (V₀) in the range from 1.9 V or more to 2.5 V or less, preferably from 2.1 V or more to 2.3 V or less.

In addition, the liquid-crystal media according to the invention have high values for the VHR in liquid-crystal cells.

In freshly filled cells at 20° C. in the cells, these are greater than or equal to 95%, preferably greater than or equal to 97%, particularly preferably greater than or equal to 98% and very particularly preferably greater than or equal to 99%, and after 5 minutes in the oven at 100° C. in the cells, these are greater than or equal to 90%, preferably greater than or equal to 93%, particularly preferably greater than or equal to 96% and very particularly preferably greater than or equal to 98%.

In general, liquid-crystal media having a low addressing voltage or threshold voltage here have a lower VHR than those having a higher addressing voltage or threshold voltage, and vice versa.

These preferred values for the individual physical properties are preferably also in each case maintained by the media according to the invention in combination with one another.

In the present application, the term “compounds”, also written as “compound(s)”, means both one and also a plurality of compounds, unless explicitly indicated otherwise.

Unless indicated otherwise, the individual compounds are generally employed in the mixtures in each case in concentrations from 1% or more to 30% or less, preferably from 2% or more to 30% or less and particularly preferably from 3% or more to 16% or less.

For the present invention, the following definitions apply in connection with the specification of the constituents of the compositions, unless indicated otherwise in individual cases:
“comprise”: the concentration of the constituents in question in the composition is preferably 5% or more, particularly preferably 10% or more, very particularly preferably 20% or more,
“predominantly consist of”: the concentration of the constituents in question in the composition is preferably 50% or more, particularly preferably 55% or more and very particularly preferably 60% or more,
“essentially consist of”: the concentration of the constituents in question in the composition is preferably 80% or more, particularly preferably 90% or more and very particularly preferably 95% or more, and
“virtually completely consist of”: the concentration of the constituents in question in the composition is preferably 98% or more, particularly preferably 99% or more and very particularly preferably 100.0%.

This applies both to the media as compositions with their constituents, which can be components and compounds, and also to the components with their constituents, the compounds. Only in relation to the concentration of an individual compound relative to the medium as a whole does the term comprise mean: the concentration of the compound in question is preferably 1% or more, particularly preferably 2% or more, very particularly preferably 4% or more.

For the present invention, “≦” means less than or equal to, preferably less than, and “≧” means greater than or equal to, preferably greater than.

For the present invention,

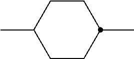

denotes trans-1,4-cyclohexylene and

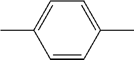

denotes 1,4-phenylene.

For the present invention, the expression “dielectrically positive compounds” means compounds having a Δ∈ of >1.5, the expression “dielectrically neutral compounds” means those where −1.5≦Δ∈≦1.5 and the expression “dielectrically negative compounds” means those where Δ∈<−1.5. The dielectric anisotropy of the compounds is determined here by dissolving 10% of the compounds in a liquid-crystalline host and determining the capacitance of the resultant mixture in each case in at least one test cell having a cell thickness of 20 μm with homeotropic and with homogeneous surface alignment at 1 kHz. The measurement voltage is typically 0.5 V to 1.0 V, but is always lower than the capacitive threshold of the respective liquid-crystal mixture investigated.

The host mixture used for dielectrically positive and dielectrically neutral compounds is ZLI-4792 and that used for dielectrically negative compounds is ZLI-2857, both from Merck KGaA, Germany. The values for the respective compounds to be investigated are obtained from the change in the dielectric constant of the host mixture after addition of the compound to be investigated and extrapolation to 100% of the compound employed. The compound to be investigated is dissolved in the host mixture in an amount of 10%. If the solubility of the substance is too low for this purpose, the concentration is halved in steps until the investigation can be carried out at the desired temperature.

The liquid-crystal media according to the invention may, if necessary, also comprise further additives, such as, for example, stabilisers and/or pleochroic dyes and/or chiral dopants in the usual amounts. The amount of these additives employed is preferably in total 0% or more to 10% or less, based on the amount of the entire mixture, particularly preferably 0.1% or more to 6% or less. The concentration of the individual compounds employed is preferably 0.1% or more to 3% or less. The concentration of these and similar additives is generally not taken into account when specifying the concentrations and concentration ranges of the liquid-crystal compounds in the liquid-crystal media.

In a preferred embodiment, the liquid-crystal media according to the invention comprise a polymer precursor which comprises one or more reactive compounds, preferably reactive mesogens, and, if necessary, also further additives, such as, for example, polymerisation initiators and/or polymerisation moderators, in the usual amounts. The amount of these additives employed is in total 0% or more to 10% or less, based on the amount of the entire mixture, preferably 0.1% or more to 2% or less. The concentration of these and similar additives is not taken into account when specifying the concentrations and concentration ranges of the liquid-crystal compounds in the liquid-crystal media.

The compositions consist of a plurality of compounds, preferably 3 or more to 30 or fewer, particularly preferably 6 or more to 20 or fewer and very particularly preferably 10 or more to 16 or fewer compounds, which are mixed in a conventional manner. In general, the desired amount of the components used in lesser amount is dissolved in the components making up the principal constituent of the mixture. This is advantageously carried out at elevated temperature. If the selected temperature is above the clearing point of the principal constituent, completion of the dissolution operation is particularly easy to observe. However, it is also possible to prepare the liquid-crystal mixtures in other conventional ways, for example using pre-mixes or from a so-called “multibottle system”.

The mixtures according to the invention exhibit very broad nematic phase ranges with clearing points of 65° C. or more, very favourable values for the capacitive threshold, relatively high values for the holding ratio and at the same time very good low-temperature stabilities at −30° C. and −40° C. Furthermore, the mixtures according to the invention are distinguished by low rotational viscosities γ₁.

It goes without saying to the person skilled in the art that the media according to the invention for use in VA, IPS, FFS or PALC displays may also comprise compounds in which, for example, H, N, O, Cl, F have been replaced by the corresponding isotopes.

The structure of the liquid-crystal displays according to the invention corresponds to the conventional geometry, as described, for example, in EP-A 0 240 379.

The liquid-crystal phases according to the invention can be modified by means of suitable additives in such a way that they can be employed in any type of, for example, ECB, VAN, IPS, GH or ASM-VA LCD display that has been disclosed to date.

Table E below indicates possible dopants which can be added to the mixtures according to the invention. If the mixtures comprise one or more dopants, it is (they are) employed in amounts of 0.01 to 4% by weight, preferably 0.1 to 1.0% by weight.

Stabilisers which can be added, for example, to the mixtures according to the invention, preferably in amounts of 0.01 to 6% by weight, in particular 0.1 to 3% by weight, are mentioned below in Table F.

For the purposes of the present invention, all concentrations are, unless explicitly noted otherwise, indicated in percent by weight and relate to the corresponding mixture or mixture component, unless explicitly indicated otherwise.

All temperature values indicated in the present application, such as, for example, the melting point T(C,N), the smectic (S) to nematic (N) phase transition T(S,N) and the clearing point T(N,I), are indicated in degrees Celsius (° C.) and all temperature differences are correspondingly indicated in differential degrees (° or degrees), unless explicitly indicated otherwise.

For the present invention, the term “threshold voltage” relates to the capacitive threshold (V₀), also known as the Freedericks threshold, unless explicitly indicated otherwise.

All physical properties are and have been determined in accordance with “Merck Liquid Crystals, Physical Properties of Liquid Crystals”, status November 1997, Merck KGaA, Germany, and apply to a temperature of 20° C., and Δn is determined at 589 nm and Δ∈ at 1 kHz, unless explicitly indicated otherwise in each case.

The electro-optical properties, for example the threshold voltage (V₀) (capacitive measurement), are, as is the switching behaviour, determined in test cells produced at Merck Japan Ltd. The measurement cells have soda-lime glass substrates and are constructed in an ECB or VA configuration with polyimide alignment layers (SE-1211 with diluent **26 (mixing ratio 1:1), both from Nissan Chemicals, Japan), which have been rubbed perpendicular to one another and effect a homeotropic alignment of the liquid crystals. The surface area of the transparent, virtually square electrodes of ITO is 1 cm².

Unless indicated otherwise, a chiral dopant is not added to the liquid-crystal mixtures used, but the latter are also particularly suitable for applications in which doping of this type is necessary.

The VHR is determined in test cells produced at Merck Japan Ltd. The measurement cells have soda-lime glass substrates and are constructed with polyimide alignment layers (AL-3046 from Japan Synthetic Rubber, Japan) with a layer thickness of 50 nm, which have been rubbed perpendicular to one another. The layer thickness is uniformly 6.0 μm. The surface area of the transparent electrodes of ITO is 1 cm².

The VHR is determined at 20° C. (VHR₂₀) and after 5 minutes in the oven at 100° C. (VHR₁₀₀) in a commercially available instrument from Autronic Melchers, Germany. The voltage used has a frequency of 60 Hz.

The accuracies of the VHR measurement values depend on the respective VHR value. The accuracy drops with reducing values. The magnitude of the deviations generally observed at values in the various size ranges are shown in the following table.

| VHR range | | |
|---|---|---|
| VHR values | | Deviation |
| from | to | (Relative)/% |
| 95.6% | 100% | +/−0.1 |
| 99.0% | 99.6% | +/−0.2 |
| 98% | 99% | +/−0.3 |
| 95% | 98% | +/−0.5 |
| 90% | 95% | +/−1 |
| 80% | 95% | +/−2 |
| 60% | 80% | +/−4 |
| 40% | 60% | +/−8 |
| 20% | 40% | +/−10 |
| 10% | 20% | +/−20 |

The stability to UV irradiation is investigated in a “Suntest CPS”, a commercial instrument from Heraeus, Germany. In this test, the sealed test cells are irradiated for 2.0 hours without additional heating. The irradiation power in the wavelength range from 300 nm to 800 nm is 765 W/m² V. A UV cut-off filter having an edge wavelength of 310 nm is used in order to simulate the so-called window glass mode. For each series of experiments, at least four test cells are investigated for each condition, and the respective results are shown as averages of the corresponding individual measurements.

The rotational viscosity is determined using the rotating permanent magnet method and the flow viscosity in a modified Ubbelohde viscometer. For liquid-crystal mixtures ZLI-2293, ZLI-4792 and MLC-6608, all products from Merck KGaA, Darmstadt, Germany, the rotational viscosity values determined at 20° C. are 161 mPa·s, 133 mPa·s and 186 mPa·s respectively, and the flow viscosity values (v) are 21 mm²·s⁻¹, 14 mm²·s⁻¹ and 27 mm²·s⁻¹ respectively.

The following symbols are used:
V₀ threshold voltage, capacitive [V] at 20° C.,
nₑ extraordinary refractive index measured at 20° C. and 589 nm,
nₒ ordinary refractive index measured at 20° C. and 589 nm,
Δn optical anisotropy measured at 20° C. and 589 nm,
∈_{⊥} dielectric susceptibility perpendicular to the director at 20° C. and 1 kHz,
∈_{∥} dielectric susceptibility parallel to the director at 20° C. and 1 kHz,
Δ∈ dielectric anisotropy at 20° C. and 1 kHz,
cl.p. or
T(N,I) clearing point [° C.],
γ₁ rotational viscosity measured at 20° C. [mPa·s],
K₁ elastic constant, “splay” deformation at 20° C. [pN],
K₂ elastic constant, “twist” deformation at 20° C. [pN],
K₃ elastic constant, “bend” deformation at 20° C. [pN], and
LTS low-temperature stability (phase stability), determined in test cells.

The following examples explain the present invention without limiting it. However, they show the person skilled in the art preferred mixture concepts with compounds preferably to be employed and the respective concentrations thereof and combinations thereof with one another. In addition, the examples illustrate the properties and property combinations that are accessible.

For the present invention and in the following examples, the structures of the liquid-crystal compounds are indicated by means of acronyms, with the transformation into chemical formulae taking place in accordance with Tables A to C below. All radicals CₙH₂ₙ₊₁, CₘH₂ₘ₊₁ and CₗH₂ₗ₊₁ or CₙH₂ₙ, CₘH₂ₘ and CₗH₂ₗ are straight-chain alkyl radicals or alkylene radicals, in each case having n, m and I C atoms respectively. Table A shows the codes for the ring elements of the nuclei of the compound, Table B lists the bridging members, and Table C lists the meanings of the symbols for the left- and right-hand end groups of the molecules. The acronyms are composed of the codes for the ring elements with optional linking groups, followed by a first hyphen and the codes for the left-hand end group, and a second hyphen and the codes for the right-hand end group. Table D shows illustrative structures of compounds together with their respective abbreviations.

TABLE A
Ring elements

| | | | |
|---|---|---|---|
| C | 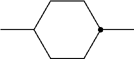 | | |
| D | 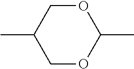 | DI | 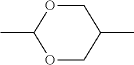 |
| A | 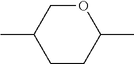 | AI | 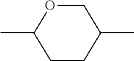 |
| P | 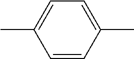 | | |
| G | 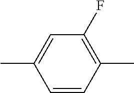 | GI | 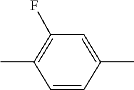 |
| U | 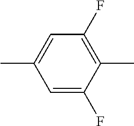 | UI | 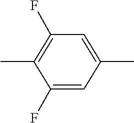 |
| Y | 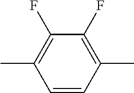 | | |
| P(F, Cl)Y | 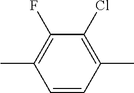 | P(Cl, F)Y | 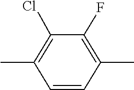 |
| np | 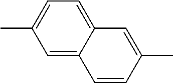 | | |
| n3f | 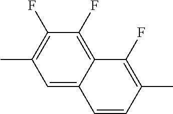 | nN3fl | 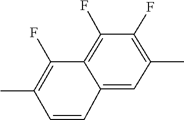 |
| th | 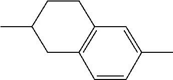 | thl | 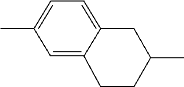 |
| tH2f | 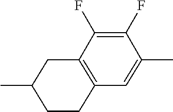 | tH2fl | 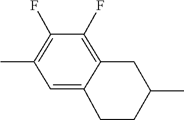 |
| o2f | 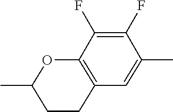 | o2fl | 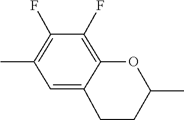 |
| dh | 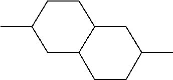 | | |
| K | 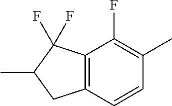 | KI | 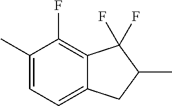 |
| L | 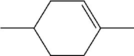 | LI | 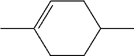 |
| F | 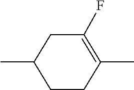 | FI | 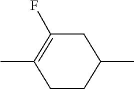 |

TABLE B
Bridging members

| | | | |
|---|---|---|---|
| E | —CH₂—CH₂— | | |
| V | —CH═CH— | | |
| T | —C≡C— | | |
| W | —CF₂—CF₂— | | |
| B | —CF═CF— | | |
| Z | —CO—O— | ZI | —O—CO— |
| X | —CF═CH— | XI | —CH═CF— |
| O | —CH₂—O— | OI | —O—CH₂— |
| Q | —CF₂—O— | QI | —O—CF₂— |

TABLE C
End groups

| On the left individually or in | | On the right individually or in | |
|---|---|---|---|
| combination | | combibination | |
| -n- | CₙH2ₙ₊₁— | -n | —CₙH₂ₙ₊₁ |
| -nO— | CₙH₂ₙ₊₁—O— | -nO | —O—CₙH₂ₙ₊₁ |
| —V— | CH₂═CH— | —V | —CH═CH₂ |
| -nV— | CₙH₂ₙ₊₁—CH═CH— | -nV | —CₙH₂ₙ—CH═CH₂ |
| —Vn- | CH₂═CH—CₙH₂ₙ— | —Vn | —CH═CH—CₙH₂ₙ₊₁ |
| -nVm- | CₙH₂ₙ₊₁—CH═CH—CₘH₂ₘ— | -nVm | —CₙH₂ₙ—CH═CH—CₘH₂ₘ₊₁ |
| —N— | N≡C— | —N | —C≡N |
| —S— | S═C═N— | —S | —N═C═S |
| —F— | F— | —F | —F |
| —CL— | Cl— | —CL | —Cl |
| —M— | CFH₂— | —M | —CFH₂ |
| —D— | CF₂H— | —D | —CF₂H |
| —T— | CF₃— | —T | —CF₃ |
| —MO— | CFH₂O— | —OM | —OCFH₂ |
| —DO— | CF₂HO— | —OD | —OCF₂H |
| —TO— | CF₃O— | —OT | —OCF₃ |
| —A— | H—C≡C— | —A | —C≡C—H |
| -nA— | CₙH₂ₙ₊₁—C≡C— | —An | —C≡C—CₙH₂ₙ₊₁ |
| —NA— | N≡C—C≡C— | —AN | —C≡C—C≡N |
| On the left only in combination | | On the right only in combination | |
| - . . . n . . . - | —CₙH₂ₙ— | - . . . n . . . | —CₙH₂ₙ— |
| - . . . M . . . - | —CFH— | - . . . m . . . | —CFH— |
| - . . . D . . . - | —CF₂— | - . . . D . . . | —CF₂— |
| - . . . V . . . - | —CH═CH— | - . . . V . . . | —CH═CH— |
| - . . . Z . . . - | —CO—O— | - . . . Z . . . | —CO—O— |
| - . . . ZI . . . - | —O—CO— | - . . . ZI . . . | —O—CO— |
| - . . . K . . . - | —CO— | - . . . K . . . | —CO— |
| - . . . W . . . - | —CF═CF— | - . . . W . . . | —CF═CF— |

in which n and m are each integers, and the three dots “ . . . ” are place markers for other abbreviations from this table.

Besides the compounds of the formula I, the mixtures according to the invention preferably comprise one or more compounds of the compounds mentioned below.

The following abbreviations are used:

(n, m and l are, independently of one another, each an integer, preferably 1 to 6, and the alkyl radicals are preferably n-alkyl radicals)

TABLE D

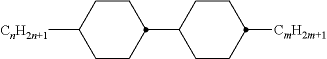

CC-n-m

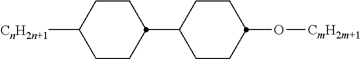

CC-n-Om

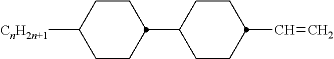

CC-n-V

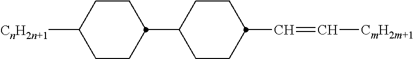

CC-n-Vm

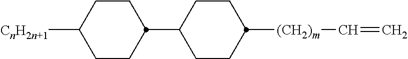

CC-n-mV

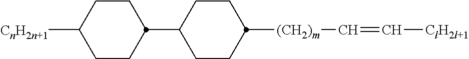

CC-n-mVl

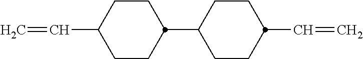

CC—V—V

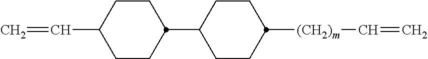

CC—V-mV

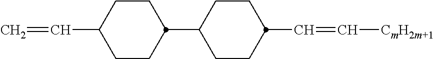

CC—V—Vm

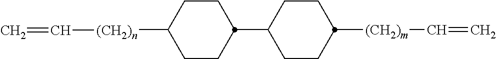

CC—Vn-mV

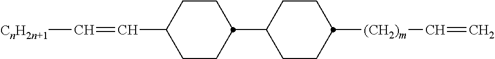

CC-nV-mV

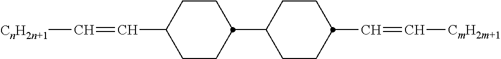

CC-nV—Vm

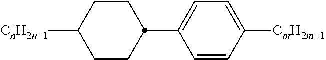

CP-n-m

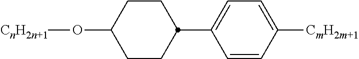

CP-nO-m

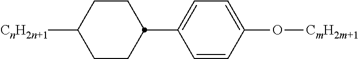

CP-n-Om

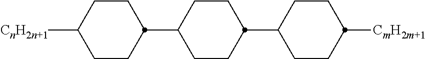

CCC-n-m

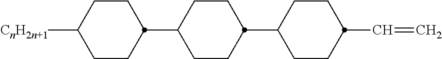

CCC-n-V

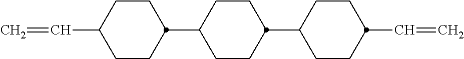

CCC—V—V

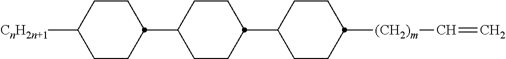

CCC-n-mV

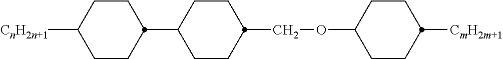

CCOC-n-m

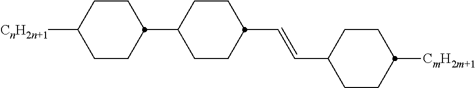

CCVC-n-m

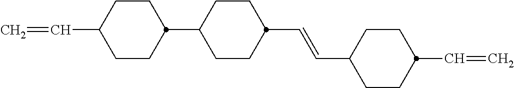

CCVC—V—V

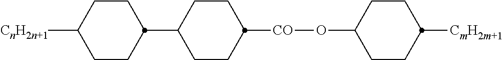

CCZC-n-Om

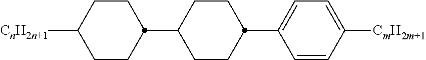

CCP-n-m

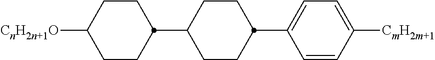

CCP-nO-m

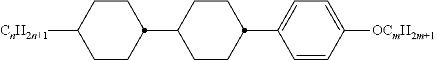

CCP-n-Om

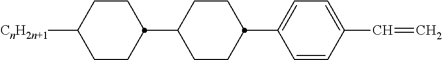

CCP-n-V

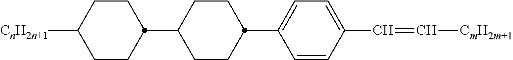

CCP-n-Vm

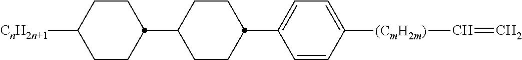

CCP-n-mV

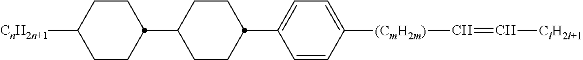

CCP-n-mVl

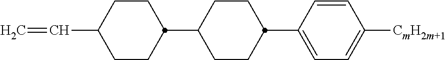

CCP—V-m

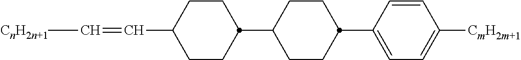

CCP-nV-m

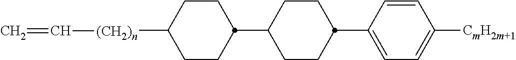

CCP—Vn-m

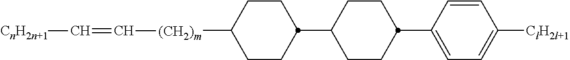

CCP-nVm-l

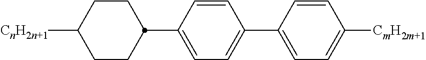

CPP-n-m

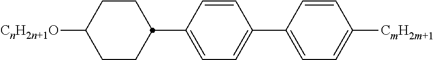

CPP-nO-m

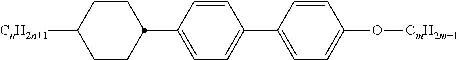

CPP-n-Om

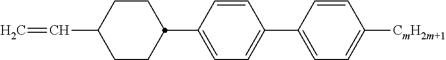

CPP—V-m

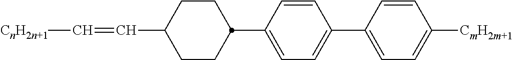

CPP-nV-m

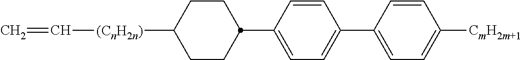

CPP—Vn-m

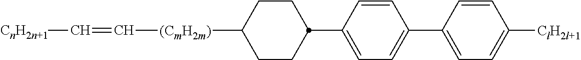

CPP-nVm-l

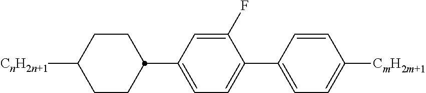

CGP-n-m

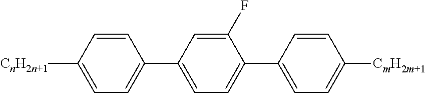

PGP-n-m

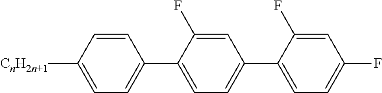

PGIGI-n-F

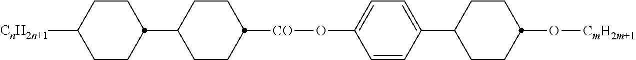

CCZPC-n-m

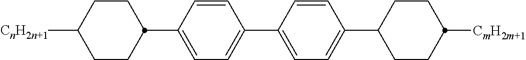

CPPC-n-m

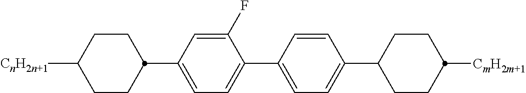

CGPC-n-m

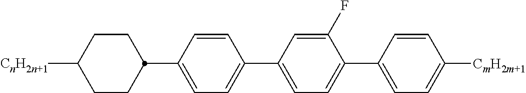

CPGP-n-m

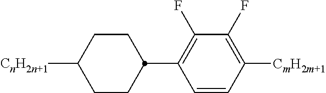

CY-n-m

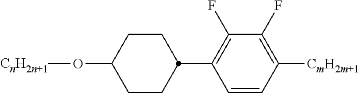

CY-nO-m

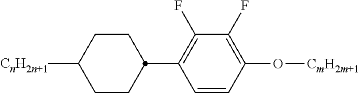

CY-n-Om

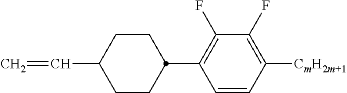

CY—V-m

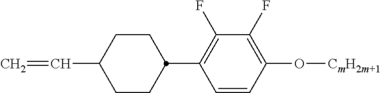

CY—V—Om

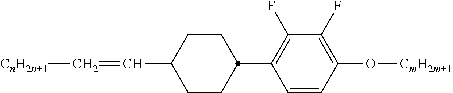

CY-nV—Om

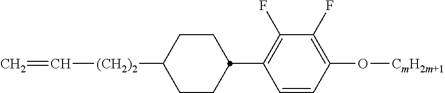

CY—V2-Om

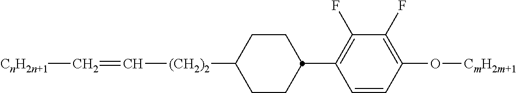

CY-nV2—Om

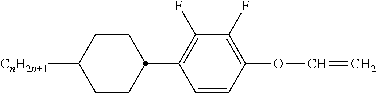

CY-n-OV

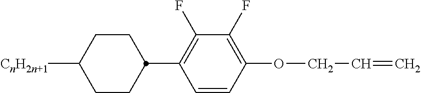

CY-n-O1V

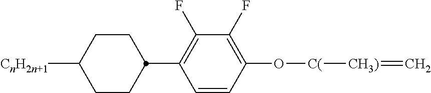

CY-n-OC(CH3)═CH2

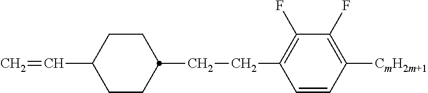

CEY—V-m

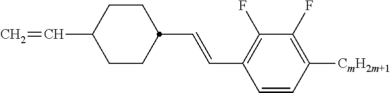

CVY-n-m

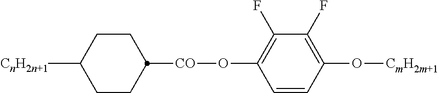

CZY-n-Om

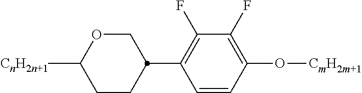

AlY-n-Om

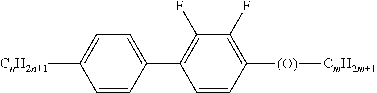

PY-n-(O)m

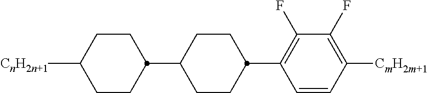

CCY-n-m

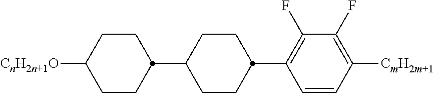

CCY-nO-m

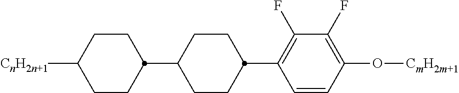

CCY-n-Om

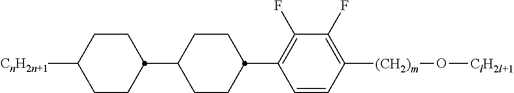

CCY-n-mOI

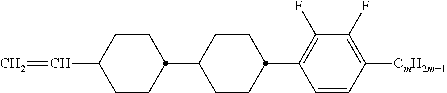

CCY—V-m

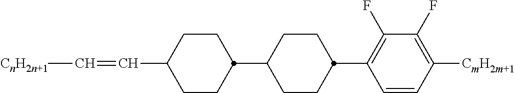

CCY-nV-m

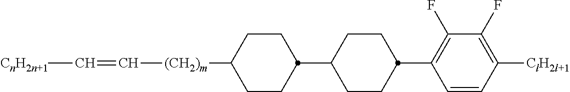

CCY-nVm-I

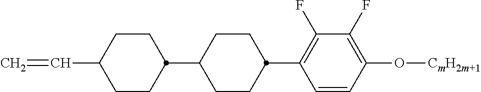

CCY—V—Om

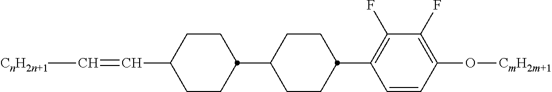

CCY-nV—Om

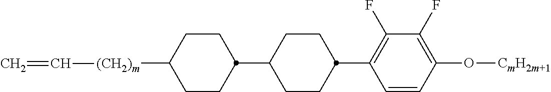

CCY—Vn-Om

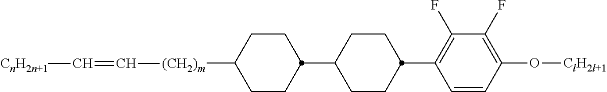

CCY-nVm-OI

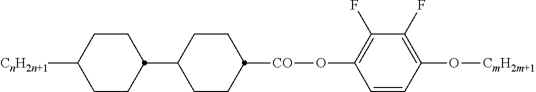

CCZY-n-Om

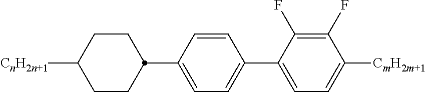

CPY-n-m

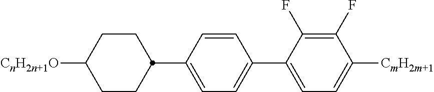

CPY-nO-m

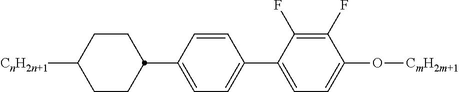

CPY-n-Om

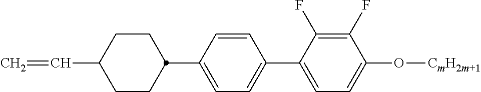

CPY—V—Om

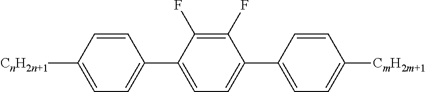

PYP-n-m

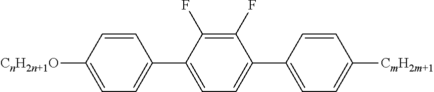

PYP-nO-m

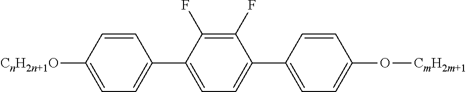

PYP-n-Om

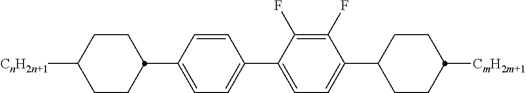

CPYC-n-m

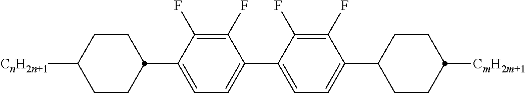

CYYC-n-m

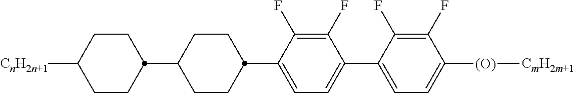

CCYY-n-(O)m

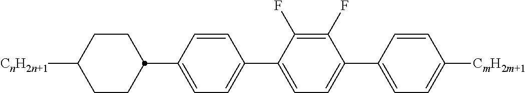

CPYP-n-m

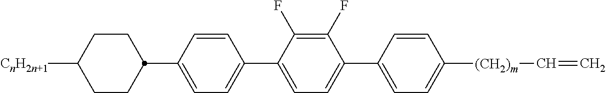

CPYP-n-mV

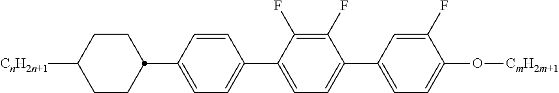

CPYG-n-Om

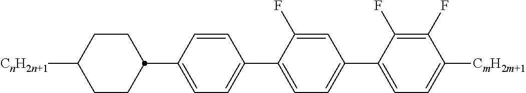

CPGIY-n-m

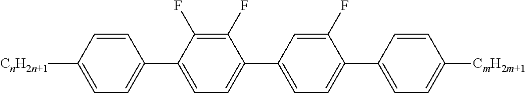

PYGP-n-m

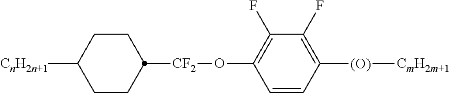

CQY-n-(O)m

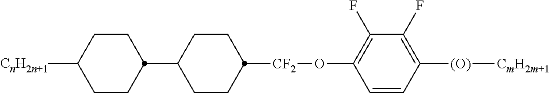

CCQY-n-(O)m

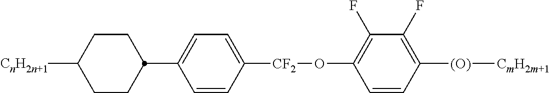

CPQY-n-(O)m

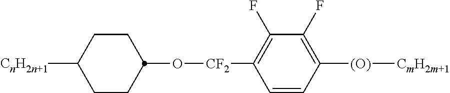

CQIY-n-(O)m

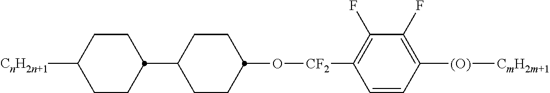

CCQIY-n-(O)m

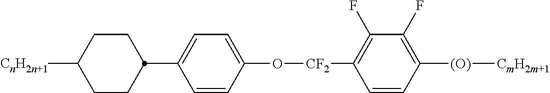

CPQlY-n-(O)m

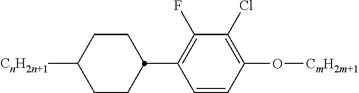

CP(F,Cl)-n-Om

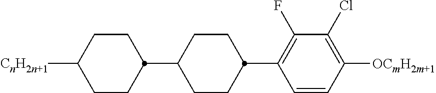

CCP(F,Cl)-n-Om

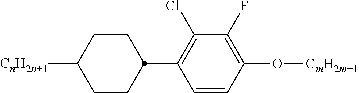

CP(Cl,F)-n-Om

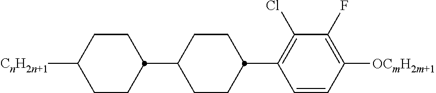

CCP(Cl,F)-n-Om

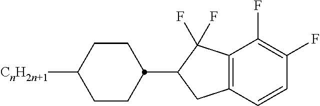

CK-n-F

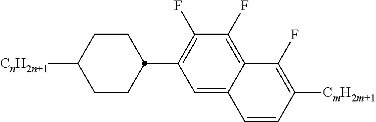

Cn3f-n-m

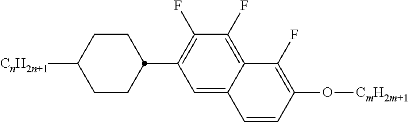

Cn3f-n-Om

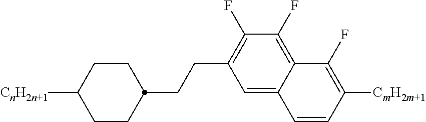

CEn3f-n-m

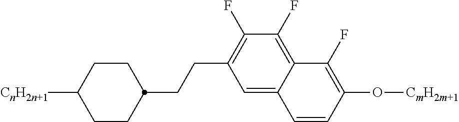

CEn3f-n-Om

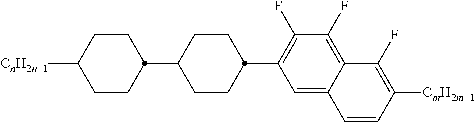

CCn3f-n-m

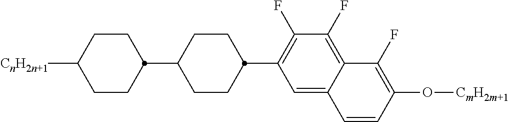

CCnef-n-Om

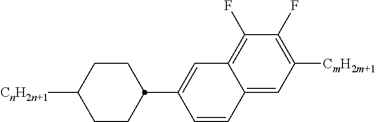

Cn2f-n-m

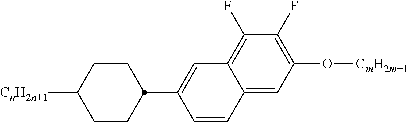

Cn2f-n-Om

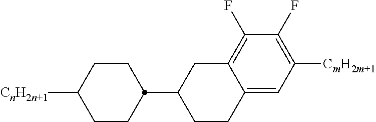

Cth2f-n-m

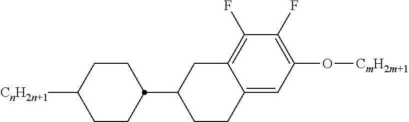

Cth2f-n-Om

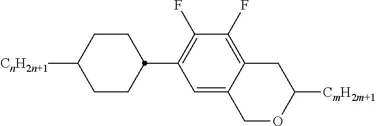

Co2fl-n-m

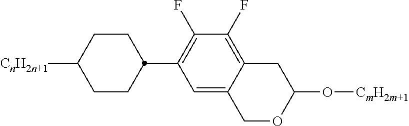

Co2fl-n-Om

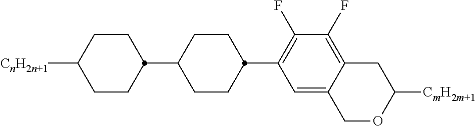

CCo2fl-n-m

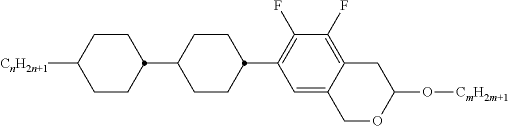

CCo2fl-n-Om

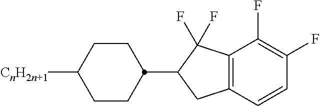

CK-n-F

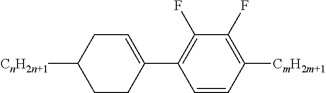

LY-n-m

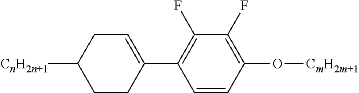

LY-n-Om

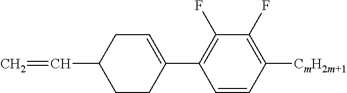

LY—V-m

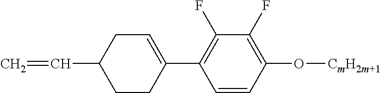

LY—V—Om

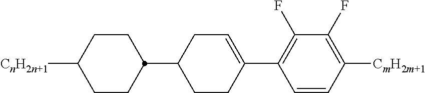

CLY-n-m

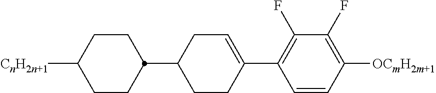

CLY-n-Om

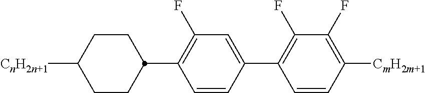

LGIY-n-m

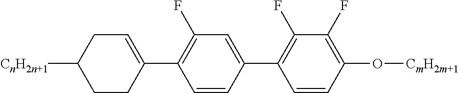

LGIY-n-Om

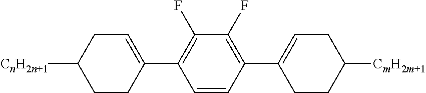

LYLI-n-m

Table E shows chiral dopants which are preferably employed in the mixtures according to the invention.

TABLE E

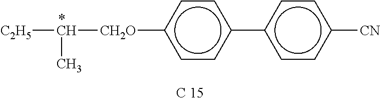

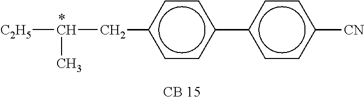

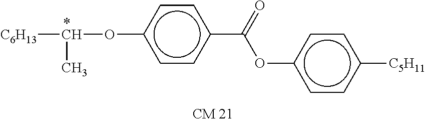

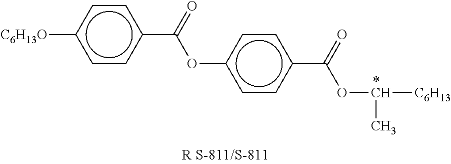

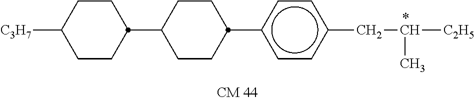

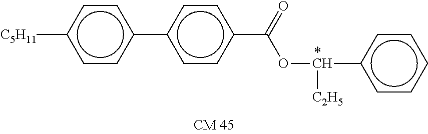

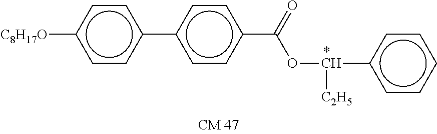

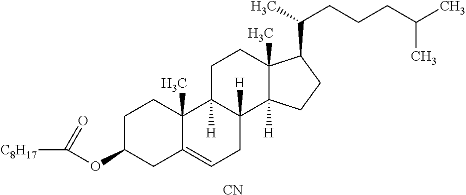

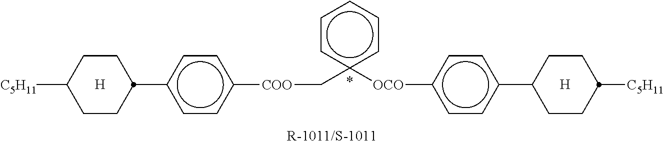

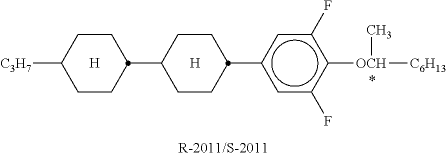

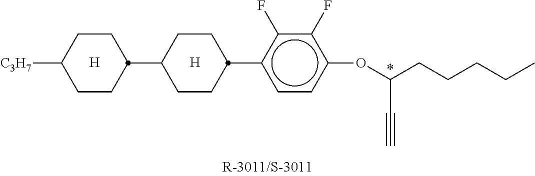

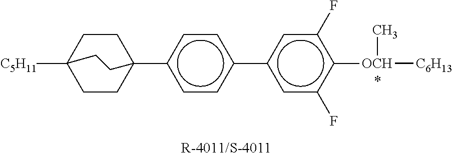

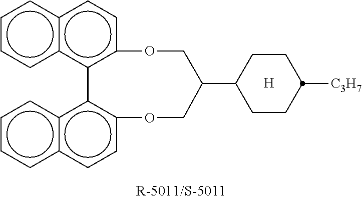

In a preferred embodiment of the present invention, the media according to the invention comprise one or more compounds selected from the group of the compounds from Table E.

Table F shows stabilisers which are preferably employed in the mixtures according to the invention.

TABLE F

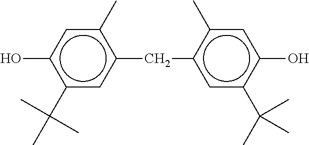

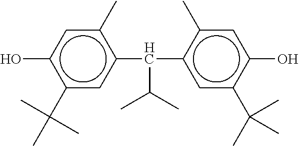

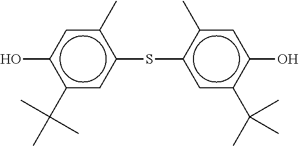

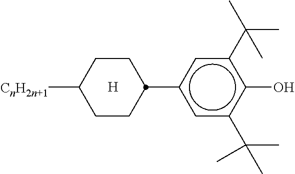

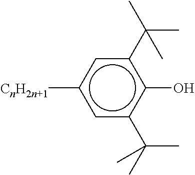

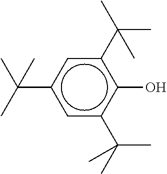

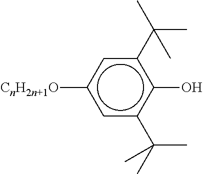

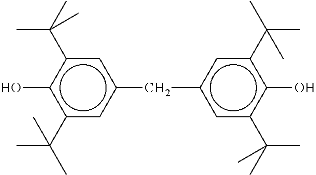

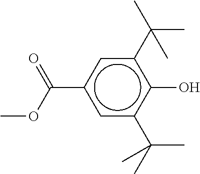

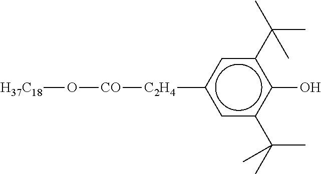

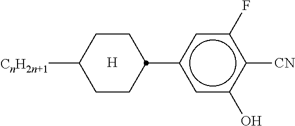

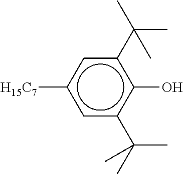

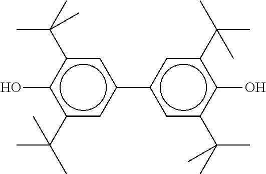

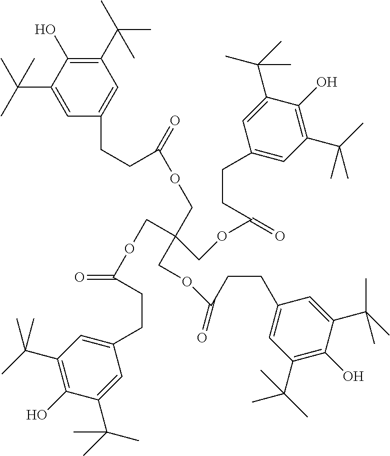

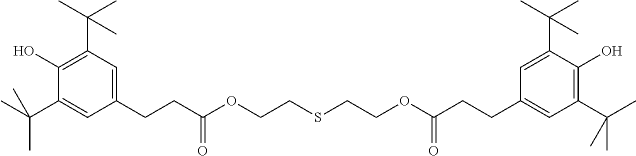

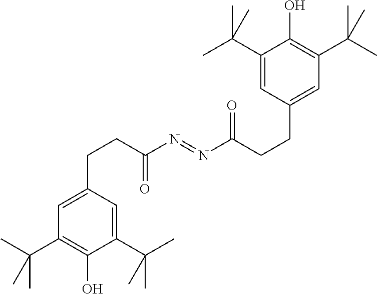

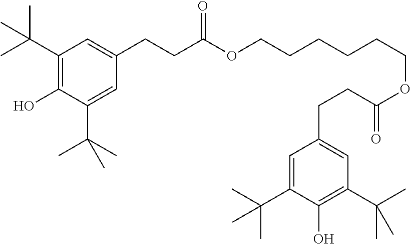

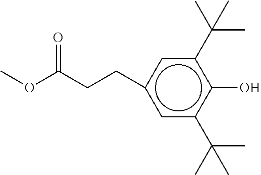

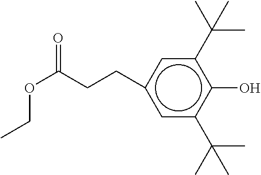

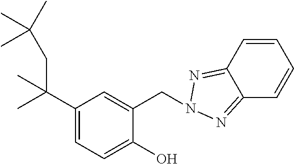

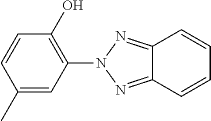

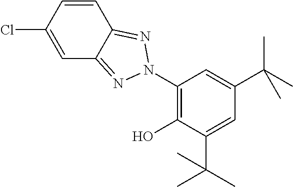

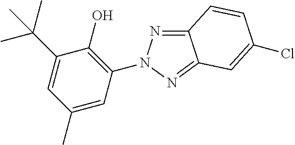

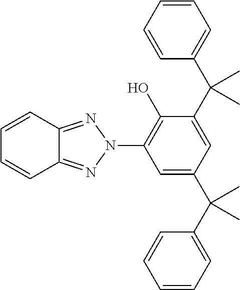

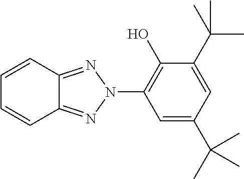

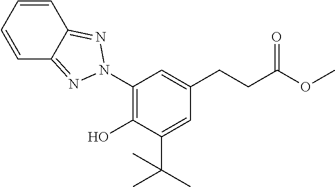

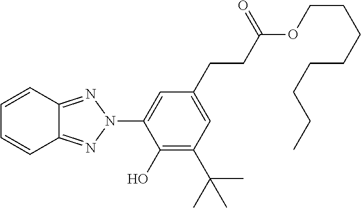

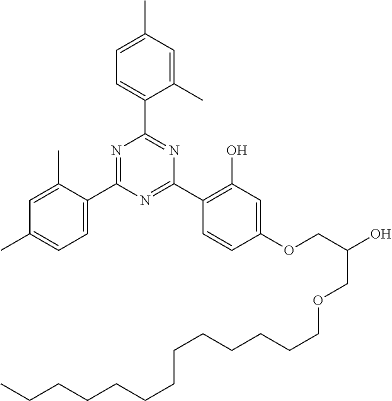

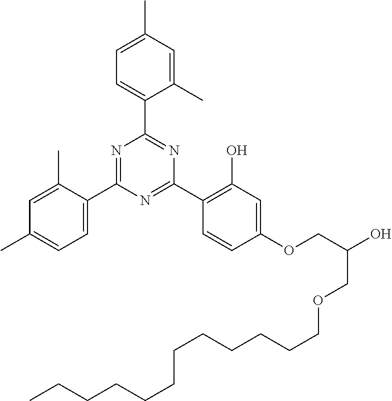

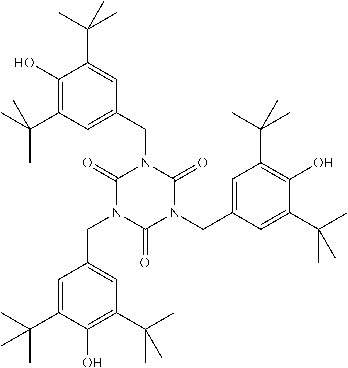

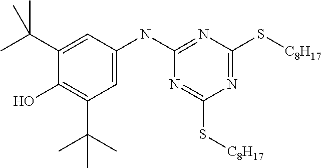

(n here denotes an integer from 1 to 12)

In a preferred embodiment of the present invention, the media according to the invention comprise one or more compounds selected from the group of the compounds from Table F.

Table G shows stabilisers selected from the group of compounds II-A to II-F which contain one or more groups of the formula II-G which are preferably employed in the mixtures according to the invention.

TABLE G

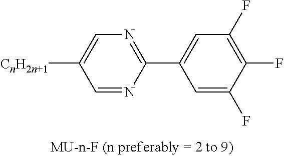

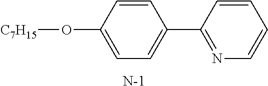

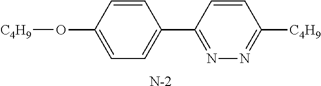

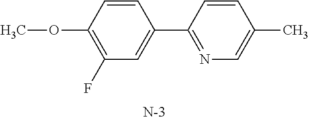

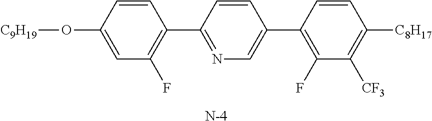

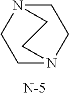

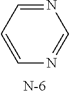

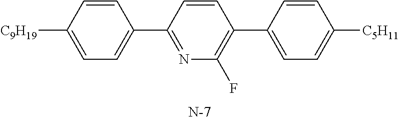

Table H shows stabilisers which contain one or more groups of the formula II-G which are preferably employed in the mixtures according to the invention.

TABLE H

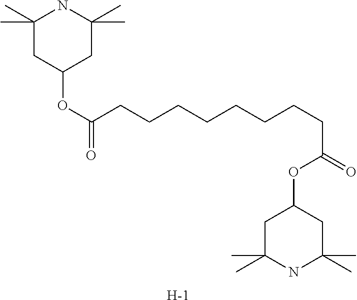

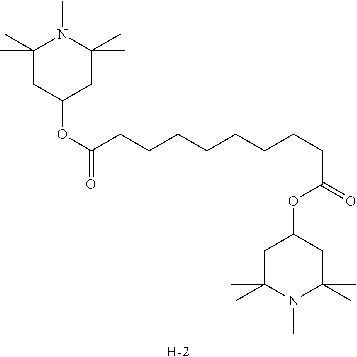

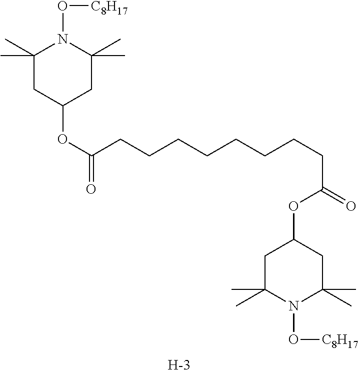

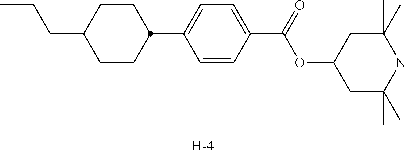

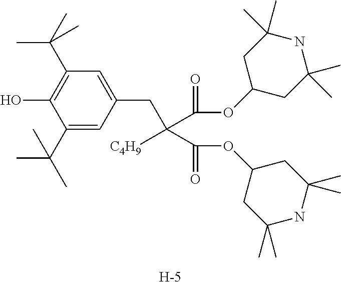

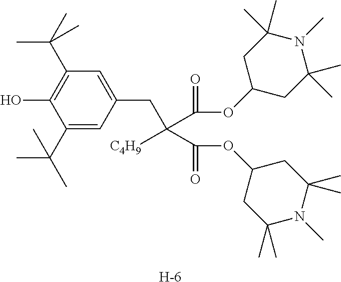

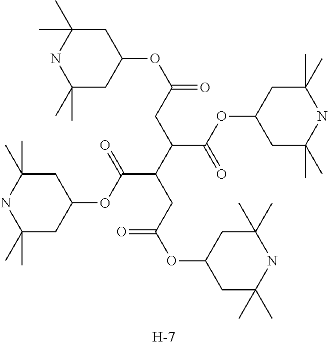

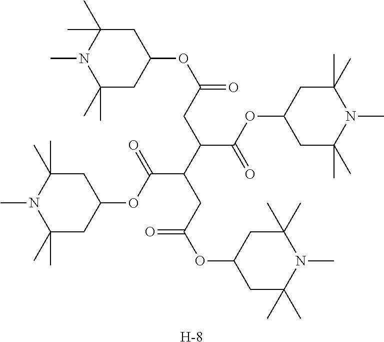

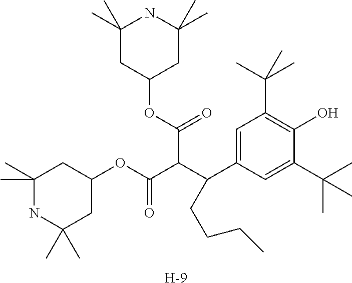

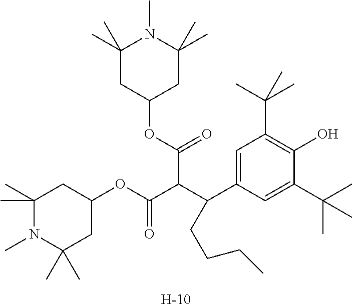

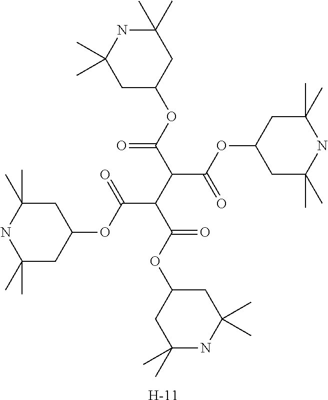

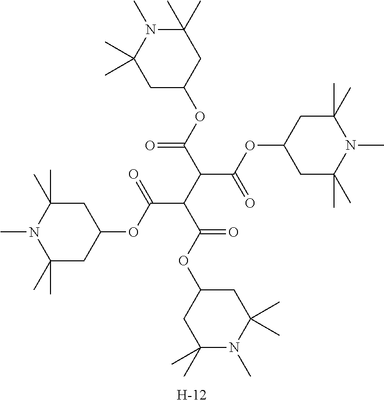

In a preferred embodiment of the present invention, the media according to the invention comprise one or more compounds selected from the group of the compounds from Table G.

### EXAMPLES

The following examples explain the present invention without restricting it in any way.

However, the physical properties make it clear to the person skilled in the art which properties can be achieved and in what ranges they can be modified. In particular, the combination of the various properties which can preferably be achieved is thus well defined for the person skilled in the art.

Liquid-crystal mixtures having the composition and properties as indicated in the following tables are prepared and investigated.

### Example 1

### Mixture A-0

Composition

| Compound | | Concentration/ |
|---|---|---|
| No. | Abbreviation | % by weight |
| 1 | CK-3-F | 3.0 |
| 2 | CK-4-F | 4.0 |
| 3 | CK-5-F | 3.0 |
| 4 | CY-5-O2 | 17.0 |
| 5 | CCY-3-O3 | 5.0 |
| 6 | CPY-2-O2 | 8.0 |
| 7 | CPY-3-O2 | 8.0 |
| 8 | PYP-2-3 | 5.0 |
| 9 | CC-3-V | 28.0 |
| 10 | CC-3-V1 | 9.0 |
| 11 | CCP-V-1 | 10.0 |
| Σ | | 100.0 |

Physical properties

T(N, I) = 75.5° C.
nₑ(20° C., 589 nm) = 1.5763
Δn(20° C., 589 nm) = 0.0951
ε_{⊥}(20° C., 1 kHz) = 6.6
Δε(20° C., 1 kHz.) = −2.9
k₁(20° C.) = 12.9 pN
k₃/k₁(20° C.) = 1.15
γ₁(20° C.) = 86 mPa · s
V₀(20° C.) = 2.39 V

The starting mixture A-0, also called host mixture or host for short below, is investigated in sealed test cells as described above with respect to its stability to heating (four hours at 150° C.) and subsequently, in addition, to UV irradiation (a Suntest instrument from Heraeus, Germany, for two hours). To this end, the VHR of the cells was in each case measured after heating at 100° C. for 5 minutes in the oven. The results for mixture A-0 are included in the following table for comparison.

The reproducibility of the voltage holding ratio values for various measurement series in which the results were low or even very low, typically in the region around 30% or even in the range from 10% to 20%, was in some cases significantly worse than the measurement accuracy in this range, which was already low anyway. However, this is not particularly critical for the present investigation since comparisons are very probably still possible within the same measurement series.

For most practical applications, however, inadequate stability must be assumed at these lowest values.

Compound MU-5-F, a compound of the formula II-A in accordance with the present application, and compound H-1, a compound which contains a group of the formula II-G, are then each added to the starting mixture. The concentration ratio of these two compounds is kept constant here at 1.0. The concentration of the two individual compounds is varied from 250 ppm via 500 ppm to 1000 ppm. The results for the resultant mixtures (A-1 to A-3) are shown in the following table. For each series of experiments, at least four test cells are investigated for each condition, and the respective results are shown as averages of the corresponding individual measurements.

| Exp. | Mixture | MU-5-F | H-1 | | VHR_{100° C.} | VHRuv |
|---|---|---|---|---|---|---|
| No. | No. | Conc./ppm | | Colour | /% | |
| 1.0a | A-0 | 0 | 0 | yellow | 21 | 12 |
| 1.1 | A-1 | 250 | 250 | colourless | 90.8 | 70.0 |
| 1.2 | A-2 | 500 | 500 | colourless | 90.0 | 66.6 |
| 1.3 | A-3 | 1000 | 1000 | colourless | 86.9 | 56.4 |

Next, 500 ppm of compound H-1 and in addition 500 ppm of one of a number of different compounds containing a nitrogen-containing heterocyclic ring are added to various samples of host mixture A-0. The respective last-mentioned compounds employed in the case of individual mixtures A-2 and A-4 to A-9 are shown in the following table. This table also shows the corresponding results.

| | Mix- | Comp. | | H-1 | | |
|---|---|---|---|---|---|---|
| Exp. | ture | | Conc/ | Conc./ | VHR_{100°C.} | VHRuv |

| | | | | | | |
|---|---|---|---|---|---|---|
| No. | No. | Abbrev. | ppm | ppm | Colour | /% |

Series 1

| | | | | | | | |
|---|---|---|---|---|---|---|---|
| 1.0a | A-0 | MU-5-F | 0 | 0 | yellow | 21 | 12 |
| 1.2 | A-2 | MU-5-F | 500 | 500 | colourless | 90.0 | 66.6 |

Series 2

| | | | | | | | |
|---|---|---|---|---|---|---|---|
| 1.0b* | A-0* | N-1 | 0 | 0 | yellow | 33 | 10 |
| 1.4 | A-4 | N-1 | 500 | 500 | colourless | 87.0 | 41 |
| 1.5 | A-5 | N-2 | 500 | 500 | colourless | 84.4 | 30 |
| 1.6 | A-6 | N-3 | 500 | 500 | colourless | 90.1 | 40.2 |
| 1.7 | A-7 | N-4 | 500 | 500 | colourless | 86.6 | 31 |
| 1.8 | A-8 | N-5 | 500 | 500 | colourless | 83.1 | 40 |
| 1.9 | A-9 | N-6 | 500 | 500 | colourless | 84.3 | 57.8 |

Note:
*new measurement series.

### Example 2

### Mixture B-0

Composition

| Compound | | Concentration/ |
|---|---|---|
| No. | Abbreviation | % by weight |
| 1 | CK-3-F | 4.0 |
| 2 | CK-4-F | 5.0 |
| 3 | CK-5-F | 4.0 |
| 4 | CY-5-O2 | 3.0 |
| 5 | CCY-3-O2 | 11.0 |
| 6 | CCY-3-O3 | 4.0 |
| 7 | CCY-4-O2 | 5.0 |
| 8 | CPY-2-O2 | 2.0 |
| 9 | CPY-3-O2 | 10.0 |
| 10 | PYP-2-3 | 8.0 |
| 11 | CC-3-V1 | 11.0 |
| 12 | CC-4-V | 19.0 |
| 13 | CC-3-4 | 2.0 |
| 14 | CC-3-O1 | 5.0 |
| 15 | CCP-V-1 | 7.0 |
| Σ | | 100.0 |

Physical properties

T(N, I) = 95.5° C.
nₑ(20° C., 589 nm) = 1.5820
Δn(20° C., 589 nm) = 0.0994
ε_{⊥}(20° C., 1 kHz) = 6.9
Δε(20° C., 1 kHz) = −3.2
k₁(20° C.) = 15.8 pN
k₃/k₁(20° C.) = 1.06
γ₁(20° C.) = 124 mPa · s
V₀(20° C.) = 2.41 V

Host mixture B-0 is investigated as described in Example 1, and 500 ppm of each of the two corresponding stabilisers are added, as for mixture A-2. The results are shown in the following table.

| Exp. | Host B-0 | MU-5-F | H-1 | | VHR_{100° C.} | VHRuv |
|---|---|---|---|---|---|---|
| No. | mixture | conc./ppm | | Colour | /% | |
| 2.0 | B-0 | 0 | 0 | yellow | 25 | 10 |
| 2.1 | B-1 | 500 | 500 | colourless | 65.5 | 45 |

### Example 3

### Mixture C-0

Composition

| Compound | | Concentration/ |
|---|---|---|
| No. | Abbreviation | % by weight |
| 1 | CK-3-F | 4.0 |
| 2 | CK-4-F | 4.0 |
| 3 | CK-5-F | 4.0 |
| 4 | CY-3-O4 | 13.5 |
| 5 | CY-5-O4 | 10.0 |
| 6 | CCY-2-1 | 3.0 |
| 7 | CCY-3-O2 | 4.0 |
| 8 | CCY-3-O3 | 4.5 |
| 9 | CPY-2-O2 | 10.0 |
| 10 | CPY-3-O2 | 6.0 |
| 11 | CC-3-V1 | 8.0 |
| 12 | CC-4-V | 13.0 |
| 13 | CCP-V-1 | 12.0 |
| 14 | CCP-V2-1 | 4.0 |
| Σ | | 100.0 |

Physical properties

T(N, I) = 80.5° C.
nₑ(20° C., 589 nm) =1.5750
Δn(20° C., 589 nm) = 0.0932
ε_{⊥}(20° C., 1 kHz) = 7.8
Δε(20° C., 1 kHz) = −3.8
k₁(20° C.) = 12.8 pN
k₃/k₁(20° C.) = 1.07
γ1(20° C.) = 135 mPa · s
V₀(20° C.) = 2.04 V

Host mixture C-0 is investigated as described in Example 1, and 500 ppm of each of the two corresponding stabilisers are added as for mixture A-2. The results are shown in the following table.

| Exp. | Mixture | MU-5-F | H-1 | | VHR_{100° C.} | VHRuv |
|---|---|---|---|---|---|---|
| No. | No. | Conc./ppm | | Colour | /% | |
| 3.0 | C-0 | 0 | 0 | yellow | 20 | 13 |
| 3.1 | C-1 | 500 | 500 | colourless | 82.1 | 63.1 |

### Example 4

### Mixture D-0

Composition

| Compound | | Concentration/ |
|---|---|---|
| No. | Abbreviation | % by weight |
| 1 | CK-3-F | 4.0 |
| 2 | CK-4-F | 4.0 |
| 3 | CK-5-F | 4.0 |
| 4 | CY-3-O4 | 19.0 |
| 5 | CY-5-O4 | 11.0 |
| 6 | CCY-3-1 | 7.0 |
| 7 | CCY-3-O2 | 10.0 |
| 8 | CCY-3-O3 | 7.0 |
| 9 | CPY-2-O2 | 10.0 |
| 10 | CC-3-V1 | 10.0 |
| 11 | CC-4-V | 3.0 |
| 12 | CCP-V-1 | 11.0 |
| Σ | | 100.0 |

Physical properties

T(N, I) = 80.0° C.
nₑ(20° C., 589 nm) = 1.5725
Δn(20° C., 589 nm) = 0.0940
ε_{⊥}(20° C., 1 kHz) = 9.3
Δε(20° C., 1 kHz) = −5.1
k₁(25° C.) = 13.1 pN
k₃/k₁(25° C.) = 1.11
γ₁(20° C.) = 182 mPa · s
V₀(25° C.) = 1.84 V

Host mixture C-0 is investigated as described in Example 1, and 500 ppm of each of the two corresponding stabilisers are added as for mixture A-2. The results are shown in the following table.

Host mixture D-0 is investigated as described in Example 1, and firstly, for comparison, 500 ppm of compound H-1 are added (mixture D-1), and 500 ppm of each of the two substances MU-5-F and H-1 are then added as for mixture A-2 from Example 1. The last experiment is repeated once. The results are shown in the following table.

| | | | | | |
|---|---|---|---|---|---|
| Exp. | Mixture | MU-5-F | H-1 | VHR_{100° C.} | VHRuv |

| | | | | |
|---|---|---|---|---|
| No. | No. | Conc./ppm | Colour | /% |

Series 1

| | | | | | | |
|---|---|---|---|---|---|---|
| 4.0a | D-0 | 0 | 0 | yellow | 17 | 15 |
| 4.1 | D-1 | 0 | 500 | yellow | 48 | 33 |
| 4.2a | D-2 | 500 | 500 | colourless | 90.8 | 70.0 |

Series 2

| | | | | | | |
|---|---|---|---|---|---|---|
| 4.0b* | D-0* | 0 | 0 | yellow | 18 | 15 |
| 4.2b* | D-2* | 500 | 500 | colourless | 80.9 | 62 |

Note:
*new measurement series.

In each case one of various nitrogen-containing stabilisers is subsequently added to various samples, as described in Examples 1.4 to 1.9. Host mixture D-0 is investigated as described in Example 1, but this time various HALS compounds are added as stabilisers. Firstly, as in Example 4.1, in each case 500 ppm of one of the two compounds H-3 and H-6 are used for comparison (mixtures D-3 and D-5 respectively), and in each case 500 ppm of one of the two compounds mentioned (H-3 and H-6) and 500 ppm of compound MU-5-F are then used simultaneously (mixtures D-4 and D-6 respectively) analogously to mixture A-2 from Example 1. The results are shown in the following table. The above results for mixtures 4.1 and 4.2 with the HALS compound H-1 are shown again for comparison. The results are shown in the following table.

| | Mix- | MU-5-F | Compound | | | | |
|---|---|---|---|---|---|---|---|
| Exp. | ture | Conc./ | | Conc./ | | VHR_{100° C.}/ | VHRuv/ |
| No. | No. | ppm | Abbr. | ppm | Colour | % | % |

Series 1

| | | | | | | | |
|---|---|---|---|---|---|---|---|
| 4.0a | D-0 | 0 | H-1 | 0 | yellow | 17 | 15 |
| 4.1 | D-1 | 0 | H-1 | 500 | colourless | 48 | 33 |
| 4.2a | D-2 | 500 | H-1 | 500 | colourless | 90.8 | 70.0 |

Series 2

| | | | | | | | |
|---|---|---|---|---|---|---|---|
| 4.0b* | D-0 | 0 | H-1 | 0 | yellow | 18 | 15 |
| 4.2b* | D-2 | 500 | H-1 | 500 | colourless | 80.9 | 61.7 |
| 4.3^{§} | D-3 | 0 | H-3 | 500 | n.d. | n.d. | n.d. |
| 4.4 | D-4 | 500 | H-3 | 500 | colourless | 34 | 30 |
| 4.5^{§} | D-5 | 0 | H-6 | 500 | yellow | 16 | 16 |
| 4.6 | D-6 | 500 | H-6 | 500 | colourless | 51 | 36 |

Notes:
*new measurement series
^{§}comparison
n.d.: not determined

1. Liquid-crystalline medium having a nematic phase and negative dielectric anisotropy which comprises
a) one or more compounds of the formula I 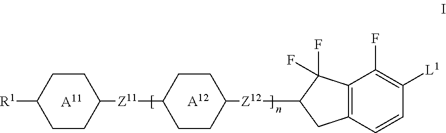
in which
R¹ denotes H, an unsubstituted alkyl or alkenyl radical having up to 15 C atoms, where, in addition, one or more CH₂ groups in these radicals may be replaced by —O—, —S—, 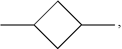
—C≡C—, —CF₂—O—, —O—CF₂—, —CO—O— or —O—CO— in such a way that O atoms are not linked directly to one another, where, in all groups, one or more H atoms may be replaced by halogen atoms,
L¹ denotes H or F, 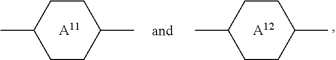
independently of one another, denote 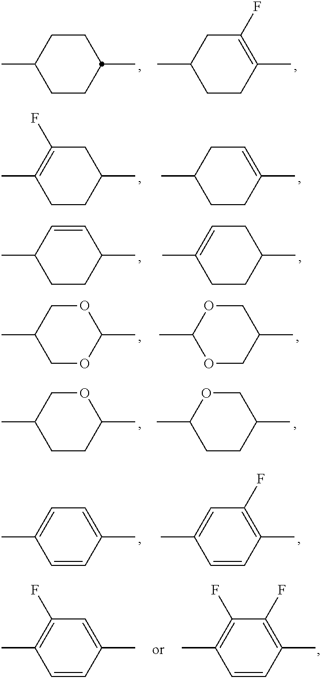
Z¹¹ and Z¹² each, independently of one another, denote —CH₂—CH₂—, —CH₂—CF₂—, —CF₂—CH₂—, —CF₂—CF₂—, —CH═CH—, —CF═CH—, —CH═CF—, —CF═CF—, —C≡C—, —CH₂—O—, —O—CH₂—, —O—, —CH₂—, —CO—O—, —O—CO—, —CF₂—O—, —O—CF₂— or a single bond, and
n denotes 0 or 1,
b) 5.0·10⁻³% by weight to 1.0% by weight of one or more compounds selected from the group of the compounds of the formulae II-A to II-F: 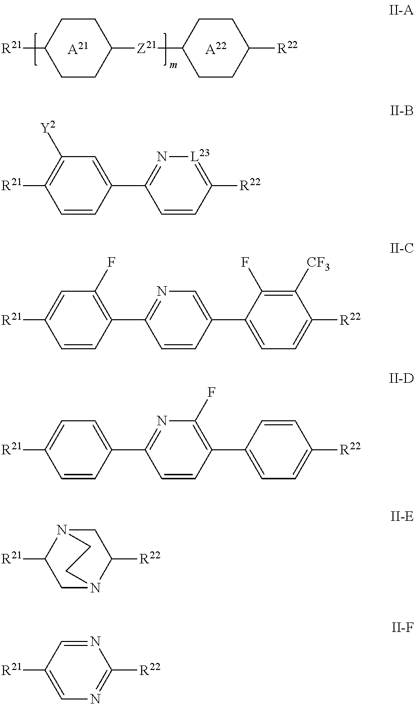
in which
R²¹ and R²² each, independently of one another, denote H, an unsubstituted alkyl or alkenyl radical having up to 15 C atoms, where, in addition, one or more CH₂ groups in these radicals may be replaced by —O—, —S—, 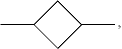
—C≡C—, —CF₂—O—, —O—CF₂—, —CO—O— or —O—CO— in such a way that O atoms are not linked directly to one another, and R²² alternatively also denotes X², and in formulae II-B and II-C R²¹ preferably denotes alkoxy and R²² preferably denotes H or alkyl,
X² denotes F, Cl, CN or —OCF₃,
one of the rings 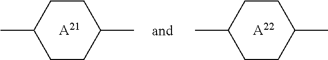
present denotes 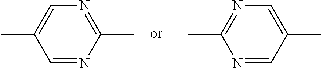
and the other, if present, denotes 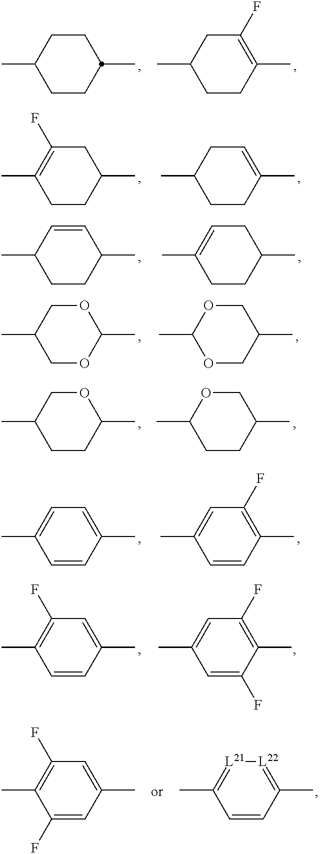
one of
L²¹ and L²² denotes ═C(—F)— or ═N— and the other denotes ═C(—F)—,
L²³ denotes ═C(—H)— or ═N—,
Y² denotes H or F,
Z²¹ denotes —CH₂—CH₂—, —CH₂—CF₂—, —CF₂—CH₂—, —CF₂—CF₂—, —CH═CH—, —CF═CH—, —CH═CF—, —CF═CF—, —C≡C—, —CH₂—O—, —O—CH₂—, —O—, —CH₂—, —CO—O—, —O—CO—, —CF₂—O—, —O—CF₂— or a single bond, and
m denotes 0 or 1,
and
c) 5.0·10⁻⁴% by weight to 1.0% by weight of one or more compounds which contain one, two or more groups of the formula II-G 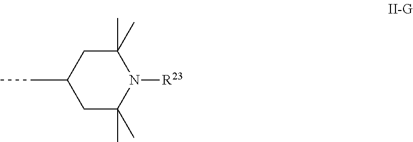
in which
R²³ denotes H or an unsubstituted alkyl radical having up to 15 C atoms, where, in addition, one or more CH₂ groups in these radicals may be replaced by —O—, —S—, 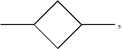
—C≡C—, —CF₂—O—, —O—CF₂—, —CO—O— or —O—CO— in such a way that O atoms are not linked directly to one another and N atoms are not linked directly either to O atoms or to S atoms.

2. Medium according to claim 1, characterised in that it comprises one or more compounds of the formula I-1 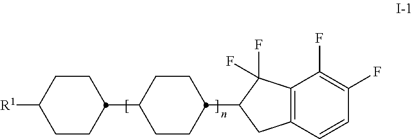
in the parameters have the respective meanings indicated in claim 1.

3. Medium according to claim 1, characterised in that it comprises one or more compounds selected from the group of the compounds of the formulae II-A-1 and II-A-2: 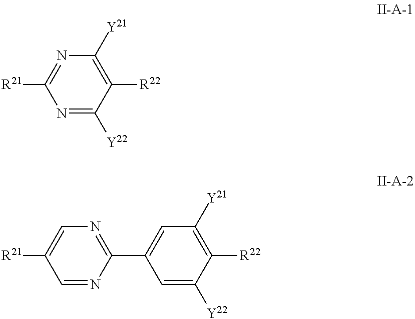
in which
Y²¹ and Y²², independently of one another, denote H or F, and
the other parameters have the respective meanings indicated in claim 1.

4. Medium according to claim 1, characterised in that it comprises one or more compounds selected from the group of the compounds of the formulae II-G-1 to II-G-7:

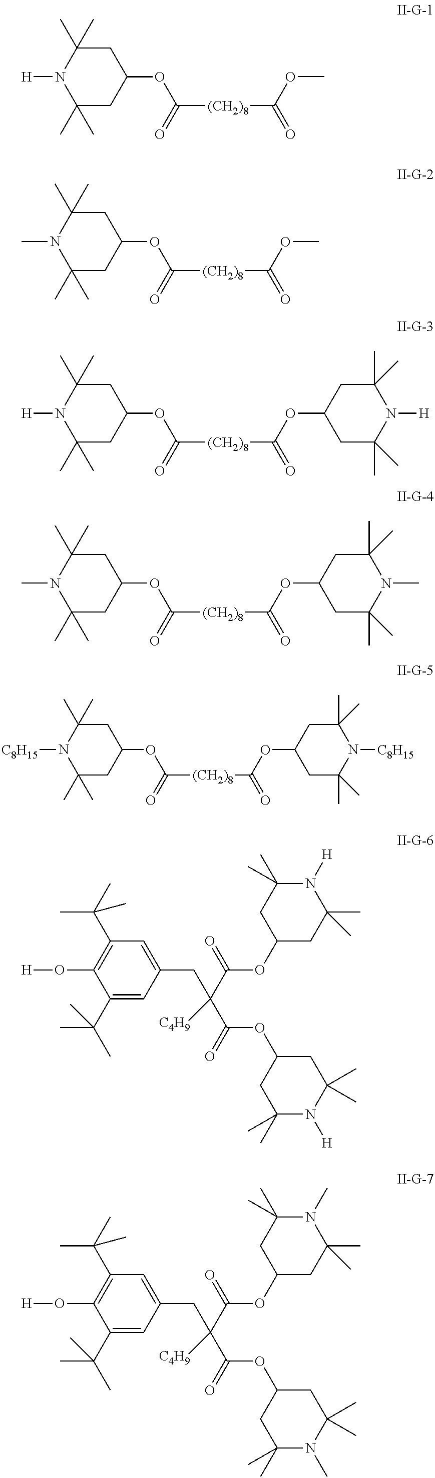

5. Medium according to claim 1, characterised in that the total concentration of the compounds of the formula I is 2% by weight or more to 40% by weight or less.

6. Medium according to claim 1, characterised in that it comprises
d) one or more compounds of the formula III 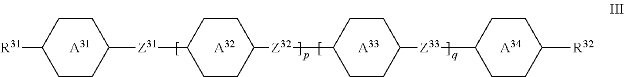
in which
R³¹ and R³² each, independently of one another, have one of the meanings given for R¹ in claim 1, 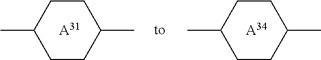
each, independently of one another, denote 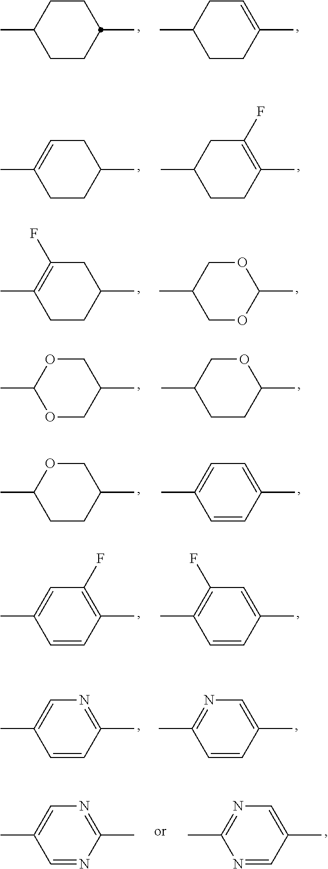
Z³¹ to Z³³ each, independently of one another, have one of the meanings given for Z¹¹ in claim 1,
p and q each, independently of one another, denote 0 or 1.

7. Medium according to claim 1, characterised in that it comprises
e) one or more compounds selected from the group of the compounds of the formulae IV and V: 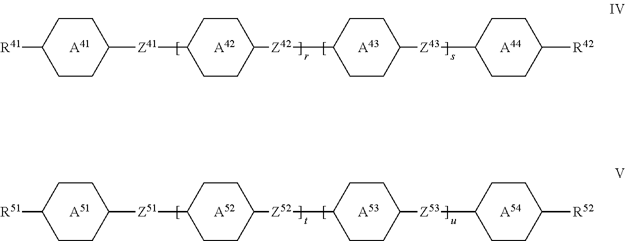
in which
R⁴¹, R⁴², R⁵¹ and R⁵² each, independently of one another, have one of the meanings given for R²¹ in claim 1,
one of the rings 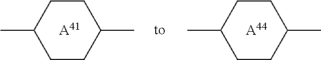
present denotes 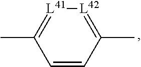
and the other rings, if present, each, independently of one another, denote 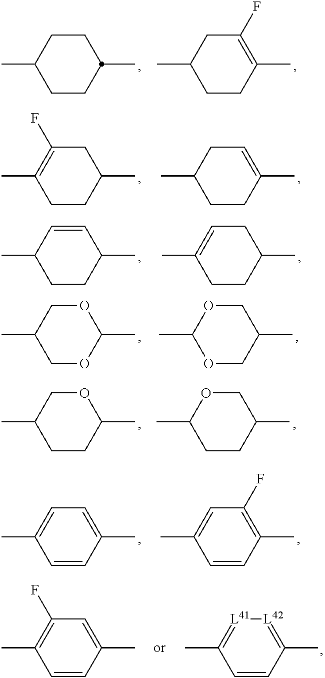
L⁴¹ and L⁴² each, independently of one another, denote ═C(X⁴)—, and one of L⁴¹ and L⁴² alternatively also denotes ═N—,
X⁴ denotes F, Cl, OCF₃, CF₃, CH₃, CH₂F, CHF₂,
one of the rings 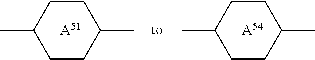
denotes 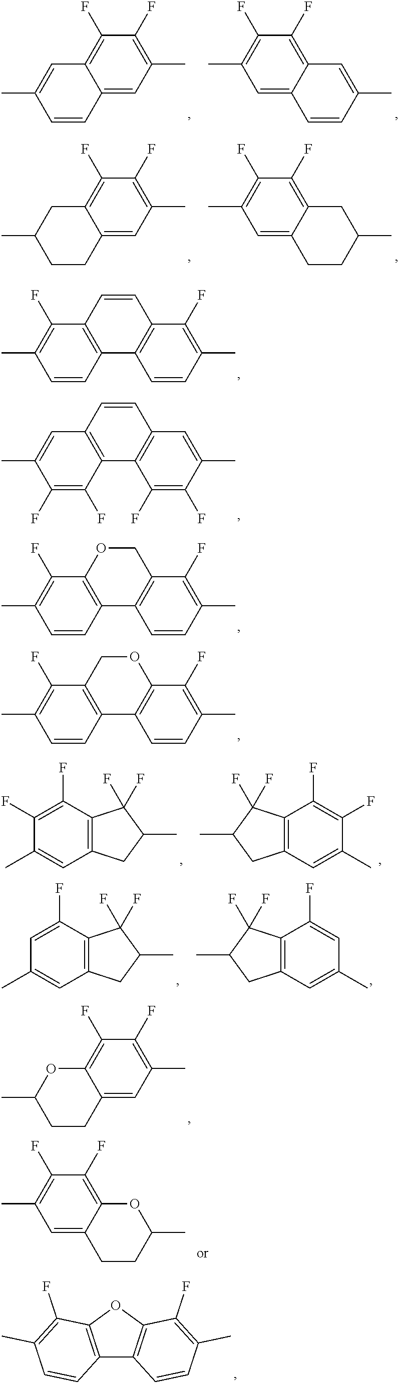
and the others, if present, each, independently of one another, denote 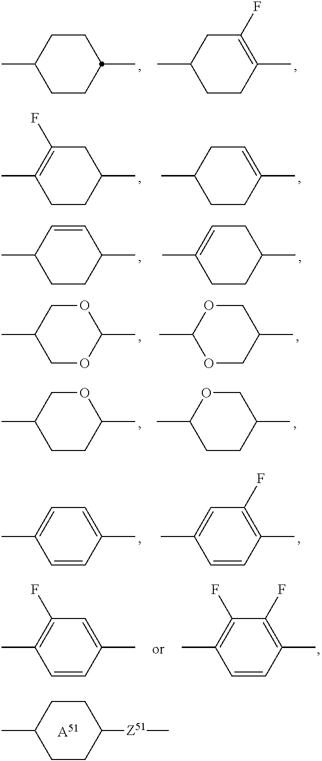
together optionally also denote a single bond,
Z⁴¹ to Z⁴³ and
Z⁵¹ to Z⁵³ each, independently of one another, have one of the meanings given for Z¹¹ in claim 1,
r and s each, independently of one another, denote 0 or 1,
t and u each, independently of one another, denote 0 or 1,
where the compounds of the formula I according to claim 1 are excluded here.

8. Medium according to claim 1, characterised in that it additionally comprises one or more chiral compounds.

9. Medium according to claim 6, characterised in that it comprises
10-60% by weight of one or more compounds of the formula III and/or
30-80% by weight of one or more compounds selected from the group of the compounds of the formulae IV and/or V,
where the total content of all compounds in the medium is 100% by weight.

10. Electro-optical display or electro-optical component, characterised in that it comprises a liquid-crystalline medium according to claim 1.

11. Display according to claim 10, characterised in that it is based on the VA or ECB effect.

12. Display according to claim 10, characterised in that it has an active-matrix addressing device.

13. A method electro-optically displaying or achieving an electro-optical effect comprising employing a liquid-crystalline medium of claim 1.

14. Process for the preparation of a liquid-crystalline medium, characterised in that one or more compounds of the formula I according to claim 1 are mixed with one or more compounds selected from the group of the compounds of the formulae II-A to II-F according to claim 1 and one or more compounds which contain one or more groups of the formula II-G according to claim 1.

15. Process for the stabilisation of a liquid-crystalline medium which comprises one or more compounds of the formula I according to claim 1, characterised in that one or more compounds selected from the group of the compounds of the formulae II-A to II-F according to claim 1 and one or more compounds which contain one or more groups of the formula II-G according to claim 1 are added to the medium.
